(19) United States
(12) Patent Application Publication
(10) Pub. No.: US 2011/0295571 A1
(43) Pub. Date: Dec. 1, 2011

(54) DIFFUSION CONCENTRATION DISTRIBUTION GENERATING METHOD AND PROCESS SIMULATOR

(75) Inventor: Kunihiro Suzuki, Kawasaki (JP)

(73) Assignee: FUJITSU LIMITED, Kawasaki-shi (JP)

(21) Appl. No.: 13/046,168

(22) Filed: Mar. 11, 2011

(30) Foreign Application Priority Data
May 27, 2010 (JP) 2010-121931

(51) Int. Cl. G06F 17/10

(52) U.S. Cl. 703/2

(57) ABSTRACT

A diffusion concentration distribution generating method conducted by a process simulator is disclosed. The process simulator calculates a defect quantity Q_{I} per unit area of the defects introduced into a semiconductor substrate by an ion implantation. Then, the process simulator calculates a location d_{I} at which a defect concentration distribution is condensed and placed in an ion implantation concentration distribution due to the ion implantation. In the process simulator, the defect concentration distribution is dealt with as a delta function.

### CROSS-REFERENCE TO RELATED APPLICATIONS

This patent application is based upon and claims the benefit of priority of the prior Japanese Patent Application No. 2010-121931 filed on May 27, 2010, the entire contents of which are incorporated herein by reference.

### FIELD

The embodiment discussed herein is related to a diffusion concentration distribution generation method and a process simulator, which generate a diffusion concentration distribution by simplifying and considering a phenomenon of Transient Enhanced Diffusion (TED).

### BACKGROUND

In a semiconductor production, after impurities are implanted to a semiconductor substrate by performing an ion implantation step, an activating step is performed using a heat treatment step to form junctions. It is known that crystal defects due to the ion implantation step influence diffusion of impurities during the heat treatment step. A phenomenon of a Transient Enhanced Diffusion (hereinafter, simply called TED) has been raised as a factor causing the diffusion of the impurity during the heat treatment step.

In order to precisely describe the TED, it is required to dynamically process a phenomenon of pairing between impurities and point defects and the like. However, there are many unknown physical constants such as a reaction factor, a reaction rate factor related to a reaction, and the like. In addition, each of these values is dispersed in a range of numerics of a few to several digits. Thus, in a case of attempting to use a model which precisely processes the phenomenon of the TED, the model includes many indefinite terms to describe experimental data. Moreover, there is a problem in which if any one of parameters concerning the phenomenon of the TED is evaluated at higher accuracy, an experienced calibration is cancelled and a new calibration is required to be performed from the beginning.
[Non-Patent Document 1] S. M. Sze, VLSI technology, McGraw-Hill, 1983, Japan
[Non-Patent Document 2] B. Baccus, T. Wada, N. Shigyo, M. Norishima, H. Nakajima, K. Inou, T. Iinuma, and H. Iwai, “A study of nonequilibrium diffusion modeling—Applications to rapid thermal annealing and advanced bipolar technologies,” IEEE Trans. on Electron Devices, vol. 39, NO. 3, pp. 648-661, 1992
[Non-Patent Document 3] E. Vandenbossche, H. Jaouen, and B. Baccus, “Modeling arsenic activation and diffusion during furnace and rapid thermal annealing,” IEDM Tech. Dig., pp. 81-84, 1995
[Non-Patent Document 4] Kunihiro Suzuki, Kazuo Kawamura, Yoshio Kikuchi, and Yuji Kataoka, “Compact model for amorphous layer thickness formed by ion implantation over wide ion implantation conditions,” IEEE Trans. on Electron Devices, vol. 53, NO. 5, pp. 1186-1192, 2006
[Non-Patent Document 5] Kunihiro Suzuki, Yoko Tada, Yuji Kataoka, Kazuo Kawamura, and Tsutomu Nagayama, “Analytical model of amorphous-layer thickness formed by high-tilt-angle As ion implantation,” IEEE Trans. on Electron Devices, vol. 55, NO. 4, pp. 1080-1084, 2008
[Non-Patent Document 6] Aditya Agarwal, Tony E. Haynes, David J. Eaglesham, Hans-J. Gossmann, Dale C. Jacobson, and John M. Poate, and Yu. E. Erokhin, “Interstitial defects in silicon from 1-5 keV Si+ ion implantation,” Appl. Phys. Lett., vol. 70, p. 3332, 1997
[Non-Patent Document 7] S. Boninelli, N. Cherkashin, and A. Clayerie, and F. Cristiano, “Evidences of an intermediate rodlike defect during the transformation of {113} defects into dislocation loops,” Appl. Phys. Lett., vol. 89, 161904, 2006
[Non-Patent Document 8] P. Calvo, A. Clayerie, N. Cherkashin, B. Colombeau, Y. Lamrani a, B. de Mauduit, and F. Cristiano, “Thermal evolution of {1 1 3} defects in silicon: transformation against dissolution,” Nuc. Inst. Meth. in Phys. Res. B, vol. 216, p. 173-177, 2004
[Non-Patent Document 9] B. Colombeau, N. E. B. Cowern, F. Cristiano, P. Calvo, Y. Lamrani, N. Cherkashin, E. Lampin, and A. Clayerie, “Depth dependence of defect evolution and TED during annealing,” Inst. Meth. Phys. Res. B, vol. 216, p. 90-94, 2004
[Non-Patent Document 10] Jinghong Li and Kevin S. Jones, “{311} defects in silicon: The source of the loops,” Appl. Phys. Lett., vol. 73, p. 3748-3750, 1998
[Non-Patent Document 11] Hugo Saleh, Mark E. Lawa, Sushil Bharatan, Kevin S. Jones, and Viswanath Krishnamoorthy, and Temel Buyuklimanli, “Energy dependence of transient enhanced diffusion and defect kinetics,” Appl. Phys. Lett., vol. 77, p. 112-114, 2000
[Non-Patent Document 12] Kunihiro Suzuki, Hiroko Tashiro, Yoko Tada, and Yuji Kataoka, “Anomalous phosphorous diffusion,” IEEE Trans. on Electron Devices, vol. 49, pp. 2031-2035, 2002
[Non-Patent Document 13] T. Y. Tan, U. Goesele, “Point defects, diffusion processes and swirl defect formation in silicon,” J. Appl. Phys., vol. 37, p. 1, 1985
[Non-Patent Document 14] G. B. Bronner, J. D. Plummer, “Lettering of gold in silicon: A toll for understanding the properties of silicon interstitials,” J. Appl. Phys., vol. 61, p. 5286-5298, 1987
[Non-Patent Document 15] H. Zimmermann, H. Rysse, “Gold and platinum diffusion: The key to the understanding of intrinsic point defect behavior in silicon,” Appl. Phys. A, vol. 55, p. 121, 1992
[Non-Patent Document 16] C. Boit, F. Lau, R. Sittig, “Gold diffusion in silicon by rapid optical annealing,” Appl. Phys. A, vol. 50, p. 197, 1990
[Non-Patent Document 17] F. F. Morehead, E. Rorris, R. R. O'Brien, R. F. Lever, J. P. Peng, G. R. Srinivasan, “Fast simulation of coupled defect-impurity diffusion in FINDPRO: Comparison with TSUPREM IV and other programs,” J. Electrochem. Soc., vol. 138, p. 3789-3793, 1991
[Non-Patent Document 18] H.-J. Gossmann, C. S. Rafferty, H. S. Luftman, F. C. Unterwald, T. Boone, J. M. Poate, “Oxidation enhanced diffusion in Si B-doping superlattices and Si self-interstitial diffusivities,” Appl. Phys. Lett., vol. 63, p. 639-641, 1993
[Non-Patent Document 19] H. Bracht, N. A. Stolwijk, and H. Mehrer, “Properties of intrinsic point defectsin silicon determined by zinc diffusion experiments under nonequilibrium conditions,” Physical review B, vol. 52, No. 23, pp. 16542-16560, 1995
[Non-Patent Document 20] H. Y. Tan, U. Goesele, “Point defects, diffusion process and swirl defect formation in silicon,” J. Appl. Phys., vol. 37, p. 1, 1985
[Non-Patent Document 21] S. T. Dunham, “A quantitative model for the coupled diffusion of phosphorous and point defect in silicon,” J. Electrochem. Soc., vol. 139. p. 2628-2636, 1992
[Non-Patent Document 22] K. Suzuki, “Model for transient enhanced diffusion of ion-implanted boron, arsenic, and phosphorous over wide range of process conditions,” Fujitsu Sci. Tech., vol. 39, pp. 138-149, 2003
[Non-Patent Document 23] K. Suzuki, “Modeling for Diffusion and Activation of Ion Implanted Impurities”, Japan Society of Applied Physics, 2p-V-6, p. 58, 2004
[Non-Patent Document 24] F. J. Morin and J. P. Maita, “Electrical properties of silicon containing arsenic and boron,” Physical Review, Vol. 96, pp. 28-35, 1954
[Non-Patent Document 25] S. Boninelli, N. Cherkashin, and A. Clayerie, and F. Cristiano, “Evidences of an intermediate rodlike defect during the transformation of {113} defects into dislocation loops,” Appl. Phys. Lett., vol. 89, 161904, 2006
[Non-Patent Document 26] B. Colombeau, N. E. B. Cowern, F. Cristiano, P. Calvo, Y. Lamrani, N. Cherkashin, E. Lampin, and A. Clayerie, “Depth dependence of defect evolution and TED during annealing,” Nucl. Inst. And Meth. B, vol. 216, pp. 90-94, 2004
[Non-Patent Document 27] P. Calvo, A. Clayerie, N. Cherkashin, B. Colombeau, Y. Lamrani, B. de Mauduit, and F. Cristiano, “Thermal evolution of {113} defects in silicon: transformation against dissolution,” Nucl. Inst. And Meth. B, vol. 216, pp. 90-94, 2004, and
[Non-Patent Document 28] F. Cristiano, J. Grisolia, B. Comombeau, M. Omri, B. de Mauduit, A. Clayerie, L. F. Gilles, and N. E. B. Cowern, “Formation energies and relative stability of perfect and faulted dislocation loops in silicon,” J. Appl. Phys., vol. 87, pp. 8420-8428, 2000.

### SUMMARY

According to an aspect of the embodiment, there is provided a diffusion concentration distribution generating method performed in a process simulator including a computer having computer-readable instructions stored in a non-transitive computer-readable storage device, in which the computer-readable instructions when executed by the computer cause the computer to generate a diffusion concentration distribution, the diffusion concentration distribution generating method including calculating a defect quantity Q_{I} per unit area of the defects introduced into a semiconductor substrate by an ion implantation; and calculating a location d_{I} at which a defect concentration distribution is condensed and placed in an ion implantation concentration distribution due to the ion implantation, wherein the defect concentration distribution is dealt with as the delta function.

The object and advantages of the embodiment will be realized and attained by means of the elements and combinations particularly pointed out in the appended claims.

It is to be understood that both the foregoing general description and the following detailed description are exemplary and explanatory and are not restrictive of the embodiment as claimed.

### BRIEF DESCRIPTION OF THE DRAWINGS

FIG. 1 is a diagram illustrating a case of normalizing time by a predetermined dose;

FIG. 2A and FIG. 2B are diagrams for explaining a method to deal with a defect concentration distribution as a delta function;

FIG. 3 is a diagram for explaining flux in a case of dealing with the defect concentration distribution as the delta function;

FIG. 4 is a diagram illustrating a graph based on various reports concerning a diffusion coefficient;

FIG. 5 is a graph illustrating a concentration of an interstitial silicon in a thermal equilibrium state and a temperature dependency of solubility limit concentration of an effective interstitial silicon;

FIG. 6 is a graph illustrating a diffusion length of the interstitial silicon;

FIG. 7 is a graph illustrating an acceleration of the diffusion coefficient;

FIG. 8 is a graph illustrating an enhanced diffusion time;

FIG. 9 is a graph illustrating a relationship between the maximum diffusion concentration and an intrinsic carrier concentration at a time of an enhanced diffusion;

FIG. 10 is a table illustrating parameter values for each of impurities;

FIG. 11 is a block diagram illustrating a hardware configuration of a process simulator.

FIG. 12 is a diagram illustrating a functional configuration example of the process simulator;

FIG. 13 is a flowchart for explaining a process of how a diffusion concentration distribution occurs;

FIG. 14 is a diagram for explaining a normalization example of time until achieving a defect quantity;

FIG. 15 is a diagram illustrating an input screen example;

FIG. 16 is a diagram illustrating a setting example of a diffusion condition;

FIG. 17 is a diagram for explaining a TED end point; and

FIG. 18 is a diagram for explaining a search example of the TED end point.

### DESCRIPTION OF EMBODIMENT

In the following, an embodiment of the present invention will be described with reference to the accompanying drawings. The inventor focuses on broadly comprehending phenomenon of TED (Transient Enhanced Diffusion) in a heat treatment step to electrically activate impurities implanted into a semiconductor substrate and semi-quantitatively describing the phenomenon of the TED. In this manner, even if losing detailed physical information, it is possible to clarify a parameter dependency of the TED in the broad comprehension, and to intuitively recognize how the phenomenon of the TED depends on the parameters.

If one of parameters becomes certainly identifiable, it is possible for a simple model (hereinafter, also called a macro model) according to the embodiment to comparatively simply re-perform from a beginning. It is considered that it is effective to analyze the TED by cooperating the macro model with a detailed model.

The TED is the phenomenon which occurs in an extremely short time due to excessive point defects introduced by an ion implantation. In addition, the TED is a strenuous diffusion phenomenon with a tremendous rapid increase of a diffusion coefficient. In order to describe this phenomenon,

(a) How much degree of a defect is formed at which location by the ion implantation?
(b) How much the diffusion coefficient is increased?
(c) How much is a diffused maximum concentration?
(d) How long does the diffusion continue?
The above items (a) through (d) may be represented in a model. In the embodiment, it is attempted to express the model which successively change in response to a simple and broad condition, in which certain physics factors are reflected in the model. In a case in which experimental data are acquired, the model is made as a function to extract parameters specific to the TED.

[1. Theoretical Framework]

First, a theoretical framework capable of simply analyzing the TED will be described.

A diffusion equation is expressed by an expression (1) (refer to non-patent document 1), where N denotes an impurity concentration being diffused:

$$\frac{\partial N ( x )}{\partial t} = \frac{\partial [ {K}_{ele} {K}_{pdef} D \frac{\partial N ( x )}{\partial x} ]}{\partial x} \qquad ( 1 )$$

In the expression (1), a diffusion coefficient D is expressed by an expression (2).

$$D = {D}_{i}^{( x )} + ( \frac{p}{{n}_{i}} ) {D}_{i}^{( p )} + ( \frac{n}{{n}_{i}} ) {D}_{i}^{( m )} + {( \frac{n}{{n}_{i}} )}^{2} {D}_{i}^{( mm )} \qquad ( 2 )$$

In the expression (1), Kₑₗₑ denotes an electric field effect and is expressed by an expression (3).

$${K}_{ele} ≡ [ 1 + \frac{1}{\sqrt{1 + {( \frac{4 {n}_{i}}{N} )}^{2}}} ] \qquad ( 3 )$$

In the expression (1), K_{pdef} represents a dependency on the point defect, and is expressed by an expression (4).

$${K}_{pdef} ≡ \frac{[ I ]}{{[ I ]}^{*}} {f}_{Ieff} + \frac{[ V ]}{{[ V ]}^{*}} ( 1 - {f}_{Ieff} ) \qquad ( 4 )$$

In the expression (4), [I*] and [V*] denote an interstitial silicon concentration and a vacancy concentration at a thermal equilibrium, respectively. Regular concentrations respective to [I*] and [V*] are denoted without a sign “*”.

A diffusion coefficient D* in a thermal equilibrium state is expressed by an expression (5) as [I]=[I*] and [V]=[V*].

$${D}^{*} = {K}_{ele} D = [ 1 + \frac{1}{\sqrt{1 + {( \frac{4 {n}_{i}}{N} )}^{2}}} ] [ {D}_{i}^{( x )} + ( \frac{p}{{n}_{i}} ) {D}_{i}^{( p )} + ( \frac{n}{{n}_{i}} ) {D}_{i}^{( m )} + {( \frac{n}{{n}_{i}} )}^{2} {D}_{i}^{( mm )} ] \qquad ( 5 )$$

An impurity concentration distribution can be obtained by solving a diffusion equation which is expressed by an expression (6).

$$\frac{\partial N ( x )}{\partial t} = \frac{\partial [ {D}^{*} \frac{\partial N ( x )}{\partial x} ]}{\partial x} \qquad ( 6 )$$

However, in this case, a maximum diffusion concentration N_{diffMax} is limited by a solubility limit Nₛₒₗ. That is, an expression (7) is given.

N_{diffMax}=Nₛₒₗ (7)

The diffusion coefficient D during the TED is different from a diffusion coefficient at the thermal equilibrium. In the embodiment, a diffusion coefficient Dₑₙₕ being a constant value is assumed during a TED duration tₑₙₕ. Thus, a equation to be solved is expressed by an expression (8).

$$\frac{\partial N ( x )}{\partial t} = \frac{\partial [ {D}_{enh} \frac{\partial N ( x )}{\partial x} ]}{\partial x} \qquad ( 8 )$$

In this case, the maximum diffusion concentration N_{diffMax} is assumed to be a maximum diffusion concentration N_{TEDMax} specific to the TED. That is, an expression (9) is given.

N_{diffMax}=N_{TEDMax} (9)

As described above, it may be described how the TED duration tₑₙₕ, the diffusion coefficient Dₑₙₕ during the TED, and the maximum diffusion concentration N_{TEDMax} during the TED are determined and represented in the model according to the embodiment.

[2. Defects Introduced by Ion Implantation]

Defects introduced by the ion implantation are to be related to a dose Φ. Also, if the dose Φ is increased more than a certain amount, defect regions are overlapped and then, introduced defects will be saturated. Thus, it is assumed that a defect quantity Q_{I} introduced per unit area can be expressed by an expression (10).

$${Q}_{I} = \{ \begin{matrix}{r}_{I} Φ & for {r}_{I} Φ \leq {Q}_{Isat} \\ {Q}_{Isat} & for {r}_{I} Φ > {Q}_{Isat}\end{matrix} \qquad ( 10 )$$

In the expression (10), r_{I} denotes a proportionality constant and is defined for each impurity. A saturation value is defined for each impurity but it is considered that its dependency is small.

As described later, in the macro model according to the embodiment, the TED duration tₑₙₕ is proportional to the defect quantity Q_{I}. Accordingly, from the expression (10), the TED duration tₑₙₕ is proportional to the dose Φ in a case of a lower dose. However, there are experiment data indicating that the TED duration tₑₙₕ is not linear but is rather moderately dependent on the dose.

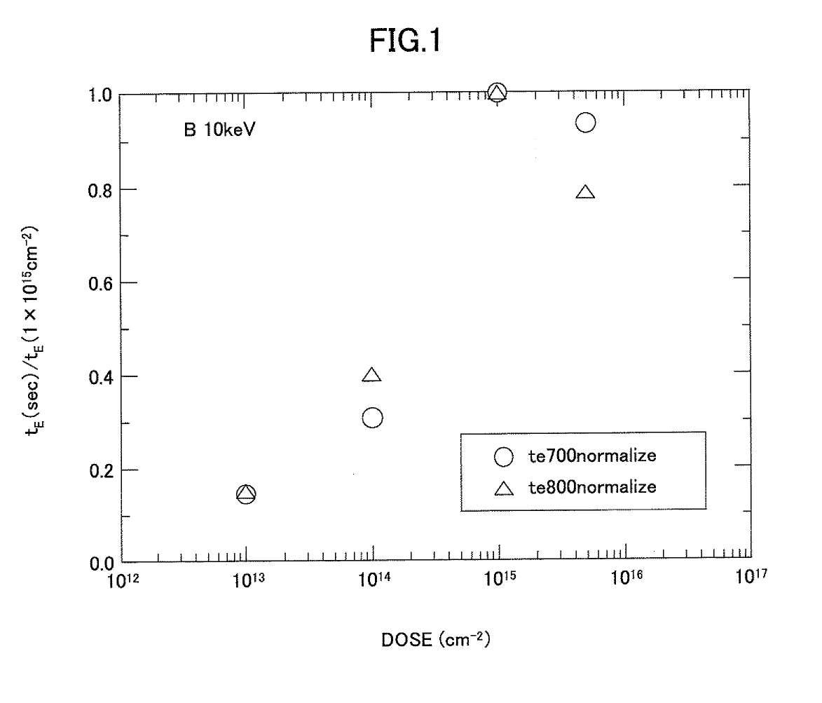

FIG. 1 is a diagram illustrating a case of normalizing time by a predetermined dose. FIG. 1 illustrates an example of normalizing time until achieving the defect quantity Q_{I} between different temperatures, by a dose 1×10¹⁵ cm⁻². A more moderate dependency than this linearity may be a phenomenon in which the more defects to be introduced, the more strenuous recombination and the more departed from the linearity. In the embodiment, this process is not applied in detail, and the dependency is represented by an expression (11) which is an experimental empirical equation.

$${Q}_{I} \{ \begin{matrix}{Q}_{Isat} ln \frac{Φ}{{Φ}_{crit}} & for Φ \leq {Φ}_{Isat} \\ {Q}_{Isat} & for Φ > {Φ}_{Isat}\end{matrix} \qquad ( 11 )$$

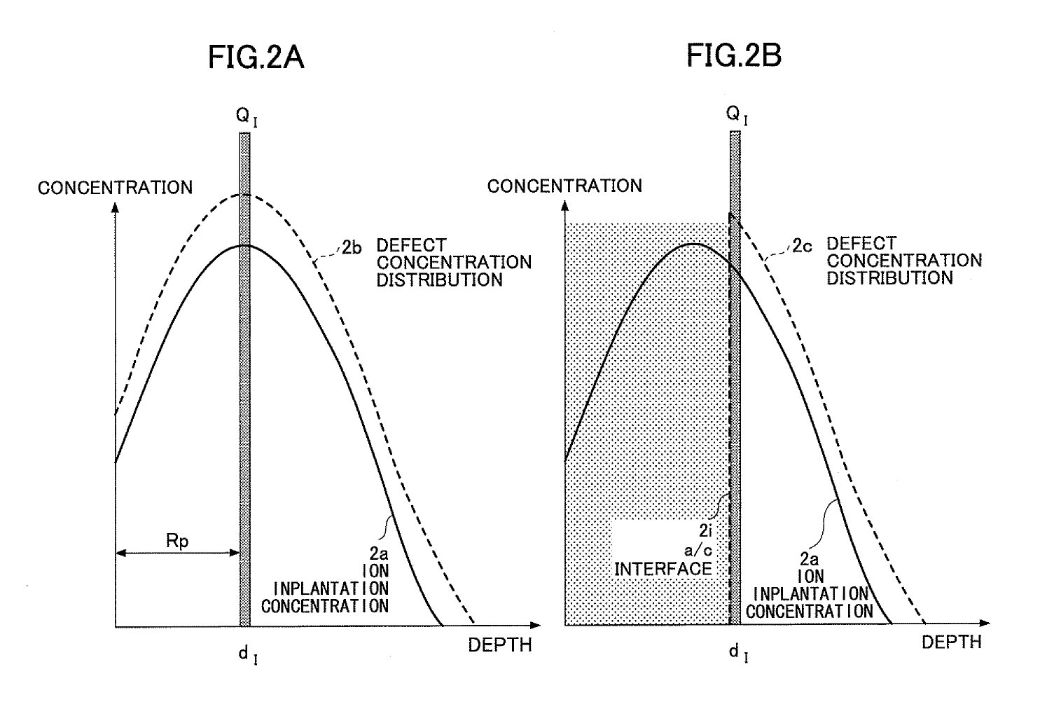

A location, at which the defect is introduced, is simply cooperated with an ion implantation concentration distribution. FIG. 2A and FIG. 2B are diagrams for explaining a method to deal with a defect concentration distribution as a delta function. In FIG. 2A and FIG. 2B, defect concentration distributions 2b and 2c, which are assumed in a regular model, are schematically illustrated by dashed line.

As illustrated in FIG. 2A, a coefficient is simply multiplied with an ion implantation concentration distribution 2a before a consecutive amorphous layer is formed. In a case in which the consecutive amorphous layer is formed, defect is set to be “0” in a region of the consecutive amorphous layer (refer to Non-Patent Documents 2 and 3).

In the embodiment, the defect concentration distribution 2b is assumed to exist at a location d_{I} as the delta function, instead of having an expanse from the ion implantation concentration distribution 2a.

In the embodiment, the location d_{I} is simply assumed as follows. Before the consecutive amorphous layer is formed, the location d_{I} is determined to be a projection range Rₚ as illustrated in FIG. 2A. After the amorphous layer is formed, the location d_{I} is defined at an interface (a/c (amorphous/channel) interface 2i) between the amorphous layer and a Si substrate (channel) in which the amorphous layer is not formed as illustrated in FIG. 2B.

In the embodiment, instead of determining the defect in the region where the consecutive amorphous layer is formed to be “0”, a model of an amorphous layer thickness (Non-Patent Documents 4 and 5) is applied to determine the defect to be the projection range Rp of an ion from a surface of a semiconductor substrate by the ion implantation. As described above, the location d_{I} is expressed and proposed as follows.

$${d}_{I} = \{ \begin{matrix}{R}_{p} & for Φ \leq 2 {Φ}_{a / c} \\ {R}_{p} + \sqrt{2} Δ {R}_{p} {erfc}^{- 1} ( \frac{2 {Φ}_{a / c}}{Φ} ) & for Φ > 2 {Φ}_{a / c}\end{matrix} \qquad ( 12 )$$

[3. Enhanced Diffusion Coefficient]

In an enhanced diffusion, first, a stable {311} defect is formed by point defects being condensed. From a region where the point defects are condensed, the point defects are released. It is considered that the point defects being released cause the enhanced diffusion (refer to Non-Patent Documents 6 through 11). In the embodiment, instead of representing a detailed process of the point defects, defects being introduced are simply represented so that all defects form clusters and the clusters release interstitial silicon which is a constant concentration. Since this manner for the defects is similar to a manner to deal with a solubility limit of the impurity, it is proposed that a solubility limit concentration Iₛₒₗ of the interstitial silicon is installed as a parameter representing the constant concentration of the point defects which are released. If the interstitial silicon concentration is I*, the diffusion coefficient related to the interstitial silicon is Iₛₒₗ/I*. Also, regarding a vacancy concentration V, I=Iₛₒₗ is applied in a relationship of I*V*=IV, and the following equation is assumed.

IₛₒₗV=I*V*

Thus, an expression (13) is acquired.

$$V = \frac{{I}^{*}}{{I}_{sol}} {V}^{*} \qquad ( 13 )$$

That is, clusters of vacancies are not explicitly considered. As described above, a coefficient concerning the diffusion coefficient Dₑₙₕ during the TED is obtained as an expression (14).

$$\frac{I}{{I}^{*}} {f}_{Ieff} + \frac{V}{{V}^{*}} ( 1 - {f}_{Ieff} ) = \frac{{I}_{sol}}{{I}^{*}} {f}_{Ieff} + \frac{{I}^{*}}{{I}_{sol}} ( 1 - {f}_{Ieff} ) \qquad ( 14 )$$

An enhanced diffusion coefficient is expressed by the above expression (14).

[4. Enhanced Diffusion Duration]

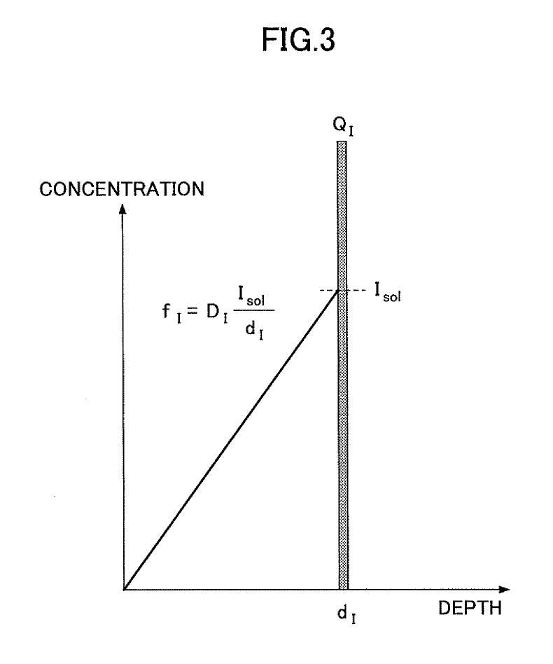

If the interstitial silicon is assumed to disappear on the surface of the semiconductor substrate alone, a simplified graph is depicted as illustrated in FIG. 3. FIG. 3 is a diagram for explaining flux in a case of dealing with the defect concentration distribution as the delta function. In FIG. 3, by assuming that the defect concentration distribution exists at the location d_{I}, the solubility limit concentration Iₛₒₗ of the interstitial silicon also exists at the location d_{I}. When the diffusion coefficient of the interstitial silicon is denoted by d_{I}, a flux f_{I} of this diffusion in FIG. 3 is expressed by an expression (15).

$${f}_{I} = {D}_{I} \frac{{I}_{sol}}{{d}_{I}} \qquad ( 15 )$$

When the flux f_{I} lasts for the TED duration tₑₙₕ, a defect quantity reaches the defect quantity Q_{I}. That is, it is assumed that the interstitial silicon, which is introduced, is entirely consumed, and the enhanced diffusion ends. That is, since f_{I}×tₑₙₕ=Q_{I}, the expression (15) is expressed as follows.

$${D}_{I} \frac{{I}_{sol}}{{d}_{I}} {t}_{enh} = {Q}_{I}$$

Therefore, the TED duration tₑₙₕ is expressed by an expression (16).

$${t}_{enh} = \frac{{d}_{I} {Q}_{I}}{{D}_{I} {I}_{sol}} \qquad ( 16 )$$

In the expression (16), d_{I}/(D_{I}×Iₛₒₗ) is 1/f_{I}.

For an ion to be implanted such as boron (B) which can form the amorphous layer, it is required to non-crystallize Silicon Si or Germanium Ge beforehand. In this case, the location d_{I} and the defect quantity Q_{I} corresponding to Silicon Si or Germanium Ge is used.

From this model, if a flux f_{Ieff} is alone, that is, if a pairing diffusion with the interstitial silicon is dominant, a diffusion length L_{Denh} related to the TED of the impurity is expressed by an expression (17).

$$\begin{matrix}{L}_{Denh} = 2 \sqrt{{D}_{enh} {t}_{enh}} \\ = 2 \sqrt{\frac{{I}_{sol}}{{I}^{*}} D \frac{{d}_{I} {Q}_{I}}{{D}_{I} {I}_{sol}}} \\ = 2 \sqrt{D \frac{{d}_{I} {Q}_{I}}{{D}_{I} {I}^{*}}}\end{matrix} \qquad ( 17 )$$

Accordingly, if a progress of the TED is ignored, in the final analysis, a diffusion degree does not depend on the solubility limit concentration Iₛₒₗ of the interstitial silicon. Also, a product of a solubility limit concentration I* and a diffusion coefficient D_{I} in the thermal equilibrium state, which are relatively well established, is simply needed. That is, it is not required to know individually respective values. Accordingly, only the defect quantity Q_{I} is an unknown parameter to depict a distribution immediately after the TED ends.

In the embodiment, the surface of the semiconductor substrate is assumed as a complete sink of the interstitial silicon. In more general, a reaction coefficient on the surface may be introduced to express the interstitial silicon concentration. When h denotes a sink coefficient on the surface, and Iₛ denotes the interstitial silicon concentration, in accordance with a balance condition of the flux, the expression (15) is modified to an expression (18).

$${D}_{I} \frac{{I}_{sol} - {I}_{s}}{{d}_{I}} = {hI}_{s} \qquad ( 18 )$$

Moreover, an expression (19) is acquired from the expression (18).

$${I}_{S} = \frac{\frac{{D}_{I}}{{d}_{I}}}{\frac{{D}_{I}}{{d}_{I}} + h} {I}_{sol} \qquad ( 19 )$$

Accordingly, the flux f_{I} of the interstitial silicon is expressed by an expression (20).

$$\begin{matrix}{f}_{I} = {D}_{I} \frac{{I}_{sol} - \frac{\frac{{D}_{I}}{{d}_{I}}}{\frac{{D}_{I}}{{d}_{I}} + h} {I}_{sol}}{{d}_{I}} \\ = \frac{1}{\frac{{D}_{I}}{{d}_{I} h} + 1} {D}_{I} \frac{{I}_{sol}}{{d}_{I}}\end{matrix} \qquad ( 20 )$$

When the sink coefficient h is a greater limit, the expression (20) is the same as the expression (15). On the other hand, when the sink coefficient h is a smaller limit, the expression (20) is expressed by an expression (21) as follows.

f_{I}≈hIₛₒₗ (21)

In the above explanation, it is ignored that the interstitial silicon disappears in depth due to the diffusion. Next, this disappearance of the interstitial silicon is considered. A diffusion equation at an arbitrary region is expressed by an expression (22).

$$\frac{\partial I}{\partial t} = {D}_{I} \frac{{\partial }^{2} I}{\partial {x}^{2}} - \frac{I}{{τ}_{I}} \qquad ( 22 )$$

A thermal balance concentration of the interstitial silicon is ignored. In the expression (22), τ_{I} denotes a recombination time. Also, since a diffusion source supplying a constant concentration is assumed, the distribution is assumed to reach an equilibrium state. Thus, the model for the phenomenon of the TED can be simplified. The expression (22) becomes an expression (23).

$${D}_{I} \frac{{\partial }^{2} I}{\partial {x}^{2}} - \frac{I}{{τ}_{I}} = 0 \qquad ( 23 )$$

By considering a border condition at a location of the diffusion source, an expression (24) is acquired.

$$I ( x ) = {I}_{sol} exp ( - \frac{x}{{L}_{DI}} ) \qquad ( 24 )$$

In the expression (24), L_{DI} denotes a diffusion length of the interstitial silicon. The diffusion length L_{DI} is expressed by an expression (25).

L_{DI}=\sqrt{D_{I}τ_{I}} (25)

The flux f_{I} is expressed by an expression (26) when X=0.

$$\begin{matrix}{f}_{I} = - {D}_{I} \frac{\partial I}{\partial x} {\vert}_{x = 0} \\ = \frac{{D}_{I} {I}_{sol}}{{L}_{DI}}\end{matrix} \qquad ( 26 )$$

Accordingly, a more general expression for the TED duration tₑₙₕ may be shown as an expression (27).

$${t}_{enh} = \frac{{Q}_{I}}{\frac{1}{\frac{{D}_{I}}{{d}_{I} h} + 1} {D}_{I} \frac{{I}_{sol}}{{d}_{I}} + \frac{{D}_{I} {I}_{sol}}{{L}_{DI}}} \qquad ( 27 )$$

It is necessary to verify how much a model expression can be simplified in addition to sufficiently correspond to the experimental data. The recombination time of the interstitial silicon is conceived. In the expression (22) indicating the diffusion equation, a recombination term is expressed by using a recombination rate k_{IV} in more general.

−k_{IV}([I][V]−[I*][V*])

If it is assumed that [I] is overwhelmingly greater in a diffusion region, and [V] is less out of a value of the thermal equilibrium, the above term is approximated and expressed as follows.

−k_{IV}[V*][I]

In this expression, a decrease of [I] due to [V] is ignored. That is, [V] is actually smaller than [V*] used in the above expression. By comparing with the expression (22), the recombination time τ_{I} is expressed as an expression (28).

$${τ}_{I} = \frac{1}{{k}_{IV} [ {V}^{*} ]} \qquad ( 28 )$$

Actually, it is predicted that the recombination time τ_{I} is longer. That is, it is estimated that the recombination time τ_{I} is shorter in the expression (28).

Other than a recombination with the above described V, as an assumption of disappearance of the interstitial silicon, a trap in a dislocation loop can be considered (refer to Non-Patent Documents 25 through 28). It is comprehended that the recombination time τ_{I} in the expression (22) includes this mechanism. If there are times τ_{I} for several mechanisms, a recombination time τ is generally expressed as follows.

$$\frac{1}{τ} = \sum \frac{1}{{τ}_{1}}$$

For respective mechanisms, this expression is used.

[5. Enhanced Diffusion Maximum Activation Concentration]

It is indicated that the maximum diffusion concentration N_{TEDMax}, at which the TED occurs, is significantly smaller than the solubility limit of the impurity. The inventor indicated that the maximum diffusion concentration N_{TEDMax} in the TED does not differ from the solubility limit but the solubility limit is misidentified, and thus, the maximum diffusion concentration N_{TEDMax} in the TED can be the solubility limit (refer to Non-Patent Document 12). Since this argument has not been established yet, both are dealt with as separate parameters in the embodiment.

Accordingly, the TED can be expressed. That is, to analyze the phenomenon of the TED, it is only needed to identify parameters of the interstitial silicon concentration I* in the thermal equilibrium state, the diffusion coefficient D_{I} of the interstitial silicon, and a proportionality constant r_{I} in the thermal equilibrium state, and a defect quantity Q_{Isat} per unit area, the solubility limit concentration Iₛₒₗ, the flux f_{Ieff} indicating a degree of the pairing diffusion, and the maximum diffusion concentration N_{TEDMax} in the TED in a saturation state. In these parameters, it is considered that the proportionality constant r_{I}, the flux f_{Ieff} indicating the degree of the pairing diffusion, and the maximum diffusion concentration N_{TEDMax} in the TED are parameters responsive to the impurity. These physical constants have not been established, and there are many reports among which constant values are different by several digits. However, since a framework of the model for the phenomenon of the TED in the embodiment is extremely simple, interim constants are applied and it is attempted to explain a great amount of experimental data. If further plausible parameters are identified, it is relatively easy to adjust the entire mode in response to the identified parameters in a case of the simple model according to the embodiment.

[6. Handling Ramp-Up Step]

Since the TED ends in a significantly shorter time, there is a case in which the TED ends during a ramp-up of a heat process. Temperature in the significantly shorter time is simply substituted for the diffusion coefficient Dₑₙₕ and the maximum diffusion concentration N_{TEDMax}. It is a problem to determine whether or not the TED is proceeding at a time during a ramp-up step. That is, it is required to conceive how to deal with the TED duration tₑₙₕ. A manner will be described in the following.

When a ramp-up rate r_{rampU} is assumed at initial temperature T₀, temperature (absolute temperature) T(t) is expressed as an expression (29).

T(t)=T₀+r_{rampU}t (29)

It is possible to determine whether or not the TED ends when a certain time lapses, by the following manner. When the TED ends at a certain temperature T_{f}, a micro-time Δt during the ramp-up is associated with an effective time Δt_{f} at the certain temperature T_{f} as follows:

$$\frac{Δ t}{{t}_{enh} ( T ( t ) )} = \frac{Δ {t}_{f}}{{t}_{enh} ( {T}_{f} )}$$

Accordingly, an expression (30) is acquired.

$$Δ {t}_{f} = \frac{{t}_{enh} ( {T}_{f} ) Δ t}{{t}_{enh} ( T ( T ) )} \qquad ( 30 )$$

Therefore, the following expression is acquired.

$${t}_{enh} ( {T}_{f} ) = {\int }_{0}^{{t}_{f}} \frac{{t}_{enh} ( {T}_{f} )}{{t}_{enh} ( T ( t ) )} d t$$

That is, a TED end time t_{f} may be found to satisfy an expression (31).

$$1 = {\int }_{0}^{{t}_{f}} \frac{1}{{t}_{enh} ( {T}_{0} + {r}_{rampU} t )} d t \qquad ( 31 )$$

In this case, a TED end temperature T_{f} at the TED end time t_{f} is expressed as an expression (32).

T_{f}=T₀+r_{rampU}t_{f} (32)

If the TED does not end during the ramp-up, an effective time t_{eff} with respect to an end temperature during the ramp-up is expressed by an expression (33).

$${t}_{eff} = {\int }_{0}^{{t}_{ramp}} \frac{1}{{t}_{enh} ( {T}_{0} + {r}_{rampU} t )} d t \times {t}_{enh} ( {T}_{0} + {r}_{rampU} {t}_{ramp} ) \qquad ( 33 )$$

At a constant temperature T₀+r_{rampU}×tᵣₐₘₚ after the ramp-up, a remaining TED time is expressed by an expression (34).

tₑₙₕ(T₀+r_{rampU}tᵣₐₘₚ)−t_{eff} (34)

After this remaining TED time lapses, by setting an activation impurity concentration N_{act} as a solubility limit, a thermal equilibrium diffusion is calculated.

[7. Application to Two Dimensions and Three Dimensions]

The simple model according to the embodiment is assumed to be one dimension. However, if a factor dominating time of the TED is the disappearance of the interstitial silicon on interstitial silicon, the factor is approximately the same in any dimension. Also, since the diffusion coefficient of the interstitial silicon is greater, as long as a region to be considered is not greatly departed from an ion implantation area, it may be recognized that a speed of the diffusion is enhanced in the entire region. In practice, an application distance is provided, and a TED model is activated only in a range of the application distance. The application distance may be approximately the diffusion length L_{DI} of the expression (24).

[8. Parameter Values]

In the following, parameter values used for the simple model will be discussed. There are various parameter values and also, there are some parameter values among which the number of digits is different. Instead of cyclopaedically explaining all parameter values, some of the parameter values will be explained and a further part of these values will be used as default values. In the following, an example how to select and modify the parameter values will be described.

[8-1. Diffusion Coefficient D_{I} and Interstitial Silicon Concentration I*]

From diffusion experiments of gold (Au) and platinum (Pt), a product of the diffusion coefficient D_{I} of the interstitial silicon and the interstitial silicon concentration I* in the thermal equilibrium state is reported as an expression (35) (refer to Non-Patent Document 13).

$${D}_{I} {I}^{*} = 4.57 \times {10}^{25} exp [ - \frac{4.84 eV}{{k}_{B} T} ] {cm}^{- 1} {s}^{- 1} \qquad ( 35 )$$

This D_{I}I* is a value which is not relatively conflicting with reported values. An activation energy of the diffusion coefficient of the impurity is lower than 4 eV. From the expression (17), the lower temperature, the longer the diffusion length of the TED of the impurity becomes. This represents the experimental data well.

Regarding the diffusion coefficient D_{I} of the interstitial silicon, various values are reported as follows.

$${D}_{I} ( {cm}^{2} / s ) = \{ \begin{matrix}600 exp [ - \frac{2.44 eV}{{k}_{B} T} ] & Bronner [ 14 ] \\ 2.58 \times {10}^{- 2} exp [ - \frac{0.965 eV}{{k}_{B} T} ] & Zimmermann [ 15 ] \\ 1.03 \times {10}^{6} exp [ - \frac{3.22 eV}{{k}_{B} T} ] & Boit [ 16 ] \\ 3.6 \times {10}^{- 4} exp [ - \frac{1.58 eV}{{k}_{B} T} ] & Morehead [ 17 ] \\ 1.0 \times {10}^{- 2} exp [ - \frac{3.1 eV}{{k}_{B} T} ] & Gossman [ 18 ] \\ 51 exp [ - \frac{1.77 eV}{{k}_{B} T} ] & Bracht [ 19 ]\end{matrix} \qquad ( 36 )$$

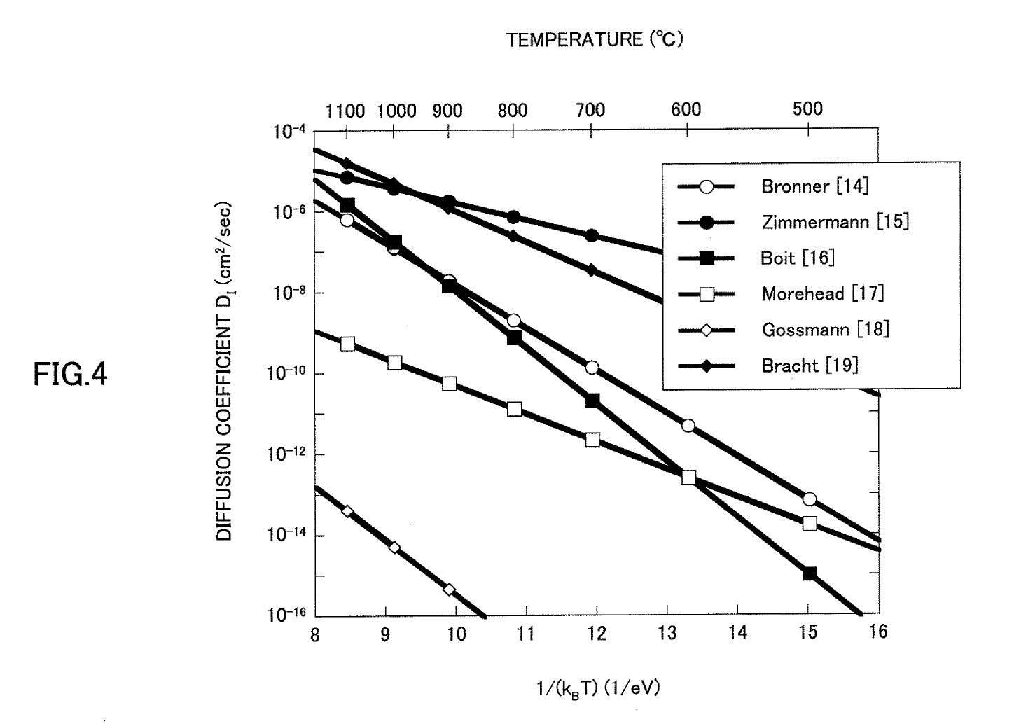

As illustrated in FIG. 4, values regarding the diffusion coefficient D_{I} are widely varied, and a discussion of which value indicates a correct diffusion coefficient has been progressed. FIG. 4 is a diagram illustrating a graph based on various reports concerning the diffusion coefficient D_{I}. In FIG. 4 and the expression (16), numerals in [ ] indicate Non-Patent Documents of respective reports concerning the diffusion coefficient D_{I} of the interstitial silicon. In FIG. 4, a vertical axis indicates the diffusion coefficient D_{I}, and a horizontal axis indicates temperature. The graph is depicted based on the reports by Bronner, Zimmermann, Boit, Morehead, Gossmann, Bracht, and the like.

Referring to FIG. 4, in a viewpoint of a diffusion potential, the reports of Bronner, Bracht, and Morehead seem to be reasonable. In the embodiment, instead of discussing physical accuracy of these reports, the reports are evaluated from a viewpoint of how a logic included in the simple model widely describes the experimental data. In a current state, as seen from FIG. 1, it should be noted that the diffusion coefficient D_{I} and the interstitial silicon concentration I* can be expressed in a remarkable broad range.

If the diffusion coefficient D_{I} of Bronner is assumed, the interstitial silicon concentration I* in the thermal equilibrium state is expressed by an expression (37).

$${I}^{*} = 7.5 \times {10}^{22} exp [ - \frac{2.4 eV}{{k}_{B} T} ] {cm}^{- 3} \qquad ( 37 )$$

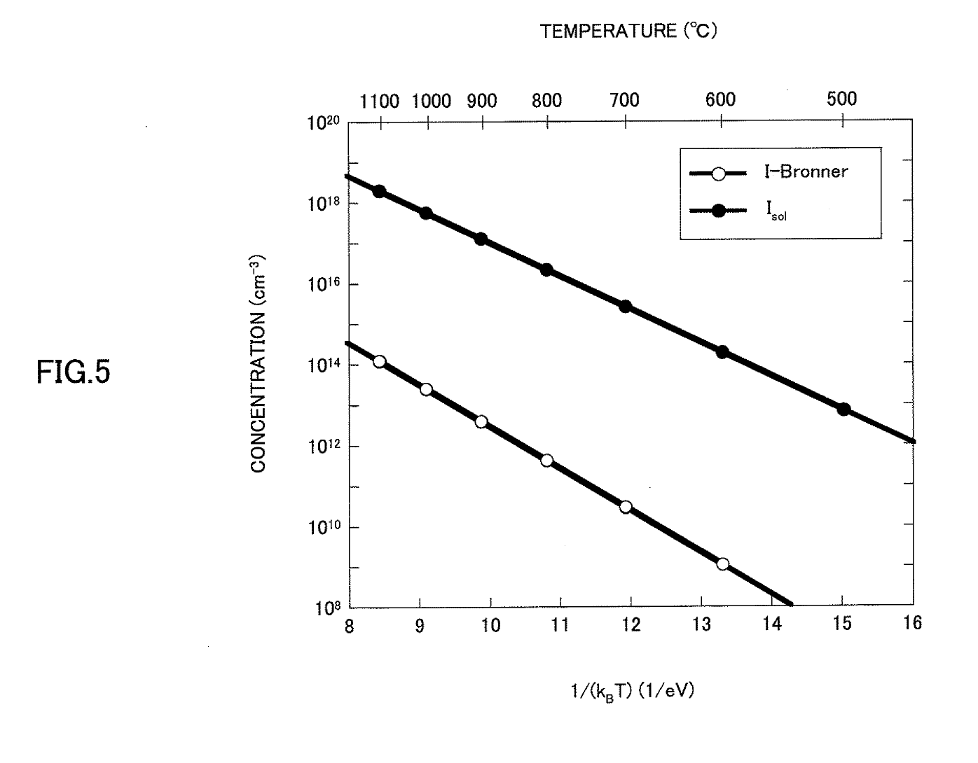

The expression (37) is depicted in FIG. 5. FIG. 5 is a graph illustrating a concentration of the interstitial silicon in the thermal equilibrium state and a temperature dependency of the solubility limit concentration of an effective interstitial silicon. In FIG. 5, a vertical axis indicates the solubility limit concentration, and a horizontal axis indicates temperature similar to that of the graph in FIG. 4. I-Bronner indicates the solubility limit concentration in the thermal equilibrium state in which the diffusion coefficient D_{I} of Bronner, and Iₛₒₗ indicates the solubility limit concentration of the effective interstitial silicon.

Referring to FIG. 5, at a significantly higher limit of the temperature, it is satisfied that a coefficient multiplied with an exponent is closer to the interstitial silicon concentration. Also, the activation energy of the diffusion coefficient is broadly 3.1 eV. This coefficient indicates a value closer to 3.46 eV of the experimental data (refer to Non-Patent Document 1). In this meaning, the report of Bronner in the expression (36) is applied in the embodiment.

Next, the diffusion length of the interstitial silicon is evaluated. A physical constant concerning the diffusion length of the interstitial silicon includes many unestablished terms. Also, regarding vacancies, from diffusion experiments of Au and Pt, a product of the diffusion coefficient D_{V} and a vacancy concentration V* in the thermal equilibrium state is expressed as an expression (38) (refer to Non-Patent Document 13).

$${D}_{V} {V}^{*} = 3.0 \times {10}^{20} exp [ - \frac{4.0 eV}{{k}_{B} T} ] {cm}^{- 1} {s}^{- 1} \qquad ( 38 )$$

Regarding the diffusion coefficient D_{V} of the vacancy concentration V*, there are reports similar to those regarding the diffusion coefficient D_{V} of the interstitial silicon concentration. In the embodiment, an expression (39) reported by Tan (refer to Non-Patent Document 20) is used.

$${D}_{V} = 0.1 exp [ - \frac{2.0 eV}{{k}_{B} T} ] {cm}^{2} {s}^{- 1} \qquad ( 39 )$$

It should be noted that the expression (39) is also one of various reports in the remarkable broad range as illustrated in FIG. 4. The vacancy concentration V* is expressed by an expression (40).

$${V}^{*} = 3.0 \times {10}^{21} exp [ - \frac{2.0 eV}{{k}_{B} T} ] {cm}^{- 3} \qquad ( 40 )$$

Regarding the recombination rate of the point defect, a report of Dunham is applied as an expression (41) (refer to Non-Patent Document 21).

$${k}_{IV} = 1.9 \times {10}^{- 9} exp [ - \frac{1.23 eV}{{k}_{B} T} ] {cm}^{- 3} {s}^{- 1} \qquad ( 41 )$$

From the expression (41), the diffusion length L_{DI} of the interstitial silicon is expressed by an expression (42).

$$\begin{matrix}{L}_{DI} = \sqrt{{D}_{I} {τ}_{I}} \\ = \sqrt{\frac{{D}_{I}}{{k}_{IV} {V}^{*}}} \\ = \sqrt{\frac{600 exp [ - \frac{2.44 eV}{{k}_{B} T} ] {cm}^{2} {s}^{- 1}}{\begin{matrix}1.9 \times {10}^{- 9} exp [ - \frac{1.23 eV}{{k}_{B} T} ] {cm}^{2} {s}^{- 1} \cdot \\ 3.0 \times {10}^{21} exp [ - \frac{2.0 eV}{{k}_{B} T} ] {cm}^{- 3}\end{matrix}}} \\ = 1.03 \times {10}^{- 5} exp [ \frac{0.04 eV}{{k}_{B} T} ] cm \\ = 10.3 exp [ \frac{0.04 eV}{{k}_{B} T} ] µm\end{matrix} \qquad ( 42 )$$

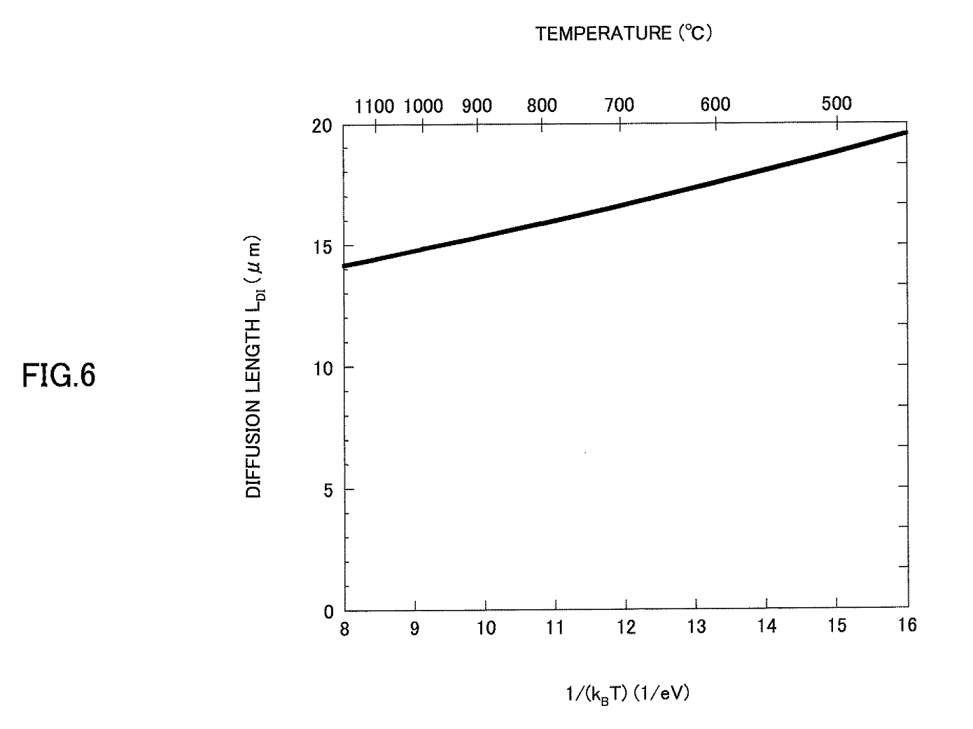

The expression (42) is depicted as illustrated in FIG. 6. FIG. 6 is a graph illustrating the diffusion length of the interstitial silicon. In FIG. 6, a vertical axis indicates the diffusion length L_{DI}, and a horizontal axis indicates temperature. As seen from FIG. 6, the diffusion length L_{DI} of the interstitial silicon has less temperature dependency and is approximately 10 μm through 20 μm.

[8.2 Solubility Limit Concentration Iₛₒₗ]

A diffusion coefficient Dₑₙₕ in the TED is expressed by an expression (43).

$${D}_{enh} \approx {f}_{Ieff} \frac{{I}_{sol}}{{I}^{*}} D \qquad ( 43 )$$

The diffusion coefficient Dₑₙₕ in the TED can be acquired by simply matching to the experimental data. In a case of boron (B), since f_{Ieff}≈1 can be assumed, the solubility limit concentration Iₛₒₗ is expressed by an expression (44).

$${I}_{sol} = \frac{{D}_{enh}}{D} {I}^{*} \qquad ( 44 )$$

In the case of boron (B), Dₑₙₕ/D was evaluated by comparing a simulation and the experimental data (refer to Non-Patent Documents 22 and 23).

When Dₑₙₕ/D is matched to the experimental data for boron (B), the Dₑₙₕ/D is acquired as an expression (45).

$$\frac{{D}_{enh}}{D} = 270 exp ( \frac{0.487}{{k}_{B} T} ) \qquad ( 45 )$$

Regarding indium (In), in the simple model according to the embodiment, since the activation energy does not depend on the impurity, the Dₑₙₕ/D is expressed by the experimental data itself for indium (In) as the following expression (46).

$$\frac{{D}_{enh}}{D} = 40 exp ( \frac{0.487}{{k}_{B} T} ) \qquad ( 46 )$$

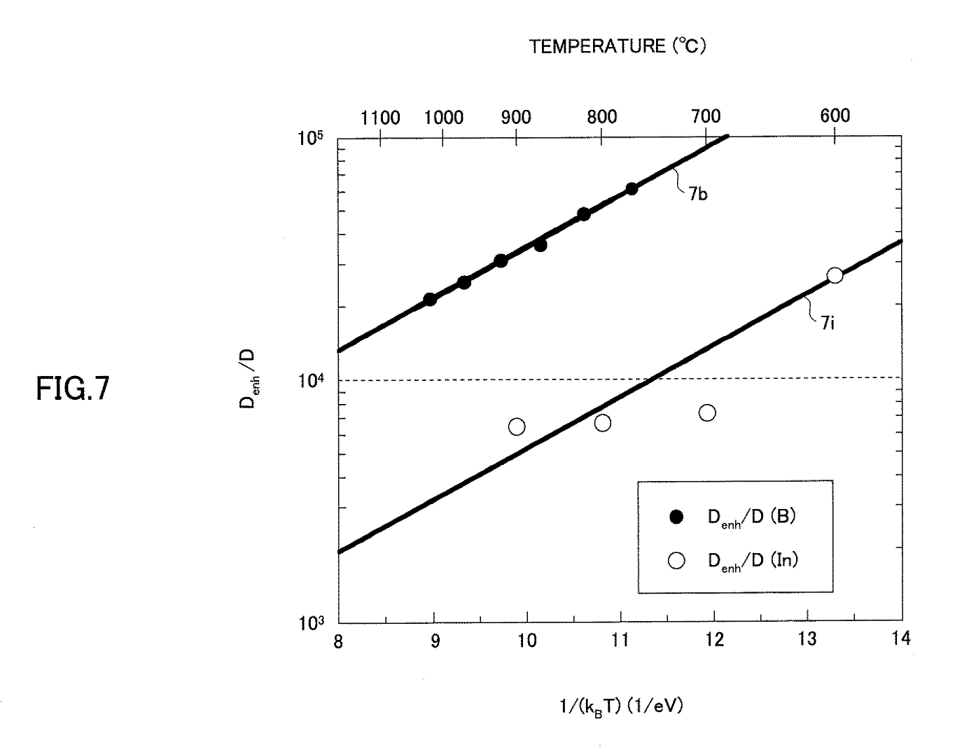

FIG. 7 is a graph illustrating an acceleration of the diffusion coefficient. In FIG. 7, a vertical axis indicates the acceleration of the diffusion coefficient and a horizontal axis indicates temperature. In FIG. 7, based on the experimental data, the acceleration of the diffusion coefficient of boron (B) is indicated by black dots, and the acceleration of the diffusion coefficient of indium (In) is indicated by white dots. Also, a straight line 7b indicates a line drawn by the expression (45) concerning the acceleration of the diffusion coefficient of boron (B), and a straight line 7i indicates a line drawn by the expression (46). The straight line 7b and the straight line 7i broadly match to the experimental data.

From the graph illustrated in FIG. 7, the flux f_{Ieff} indicating the degree of the pairing diffusion of indium (In) is expressed by an expression (47).

$${f}_{Ieff} \approx \frac{40}{270} \approx 0.15 \qquad ( 47 )$$

When the flux f_{Ieff} is “1”, the expression (47) indicates that the degree of the pairing diffusion with the interstitial silicon is dominant. Also, the expression (47) indicates that the more the flux f_{Ieff} is proximate to“0”, the less dominant but the more strongly a tendency of forming a vacancy pair becomes. That is, the simple model indicates that a main mechanism of the diffusion of indium (In) is conducted through the vacancies.

On the other hand, the flux f_{Ieff} indicating the degree of the pairing diffusion with the interstitial silicon of boron (B) is approximately “1”. Referring to FIG. 7, it is considered that if the straight line 7b indicating the acceleration of the diffusion coefficient of boron (B) is shifted in parallel, the straight line 7b approximately matches to the straight line 7i indicating the acceleration of the diffusion coefficient of indium (In). By using the Dₑₙₕ/D indicating a slope of the straight line 7b and substituting the Dₑₙₕ/D into the expression (39), an expression (48) is acquired.

$${I}_{sol} = 2.03 \times {10}^{25} exp ( - \frac{1.913 ( eV )}{{k}_{B} T} ) ( {cm}^{- 3} ) \qquad ( 48 )$$

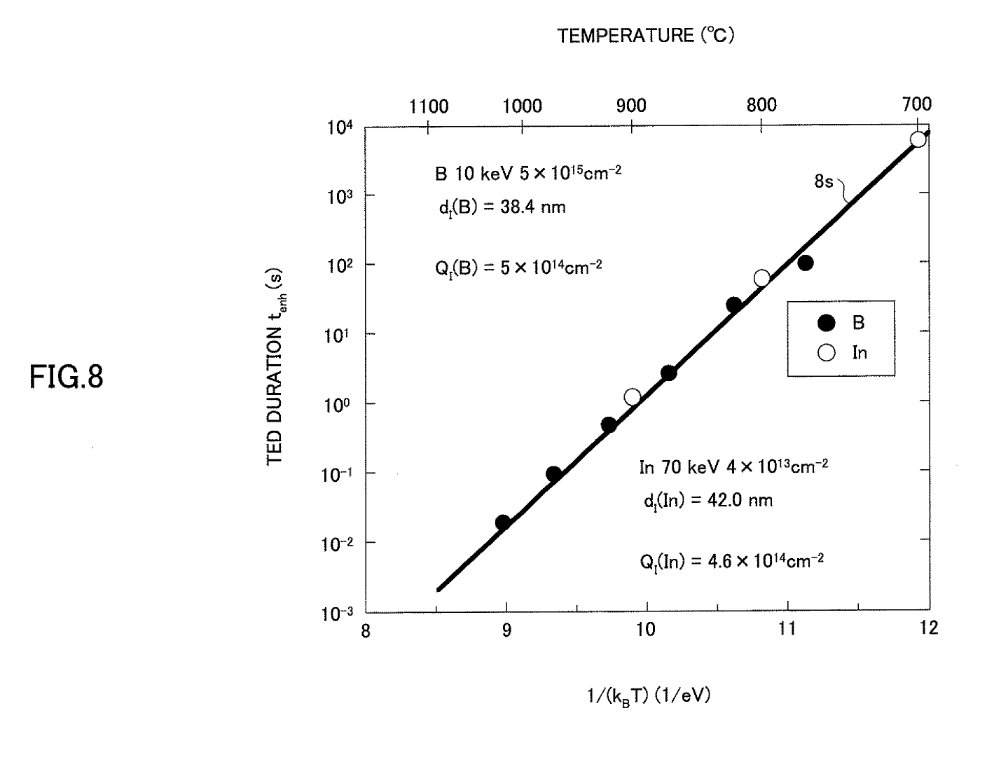

The expression (48) is illustrated in FIG. 8. In a wide temperature range, the interstitial silicon Iₛₒₗ/I* indicates a numeric of four to five digits. That is, this expresses that the enhanced diffusion coefficient is four to five digits higher than the diffusion coefficient D_{I} in the thermal equilibrium state. The enhanced diffusion coefficient is to be a parameter which does not depend on the impurity.

The TED duration tₑₙₕ is also expressed to be an enhanced diffusion time tₑₙₕ. By comparing the experimental data and the simulation, the enhanced diffusion time tₑₙₕ is extracted in a form of an activation type as illustrated in FIG. 8.

FIG. 8 is a graph illustrating the enhanced diffusion time tₑₙₕ. FIG. 8, a vertical axis indicates the diffusion length L_{DI}, and a horizontal axis indicates temperature similar to FIG. 4. In FIG. 8, based on the experimental data, the enhanced diffusion time tₑₙₕ of t boron (B) is indicated by black dots, and the enhanced diffusion time tₑₙₕ of indium (In) is indicated by white dots. Also, a result from the simulation is indicated by a straight line 8s.

The enhanced diffusion time tₑₙₕ is expressed as an expression (49).

$${t}_{enh} = 2.61 \times {10}^{- 18} exp [ - \frac{4.0 eV}{{k}_{B} T} ] sec \qquad ( 49 )$$

The enhanced diffusion time tₑₙₕ of boron (B) illustrated in FIG. 8 is extracted from the experimental data where an ion type is boron (B), an implantation energy is 10 keV, and a dose is 5×10¹⁵ cm⁻². In this condition, since the amorphous layer is not formed, the location d_{I}=Rₚ=38.4 nm. When this value of the location d_{I} is substituted into the expression (16), an expression (50) identifying the defect quantity Q_{I} is acquired

Q_{I}=5×10¹⁴ cm⁻² (50)

Due to a region of a high quantity of dose, the defect quantity Q_{I} corresponds to the defect quantity Q_{Isat} in the saturation state in a case of boron (B). The proportionality constant r_{I}=2 is applied.

Also, a result from extracting data for indium (In) from the experimental data is illustrated in FIG. 8. Regardless of increasing an implantation condition and the like, the enhanced diffusion time tₑₙₕ is astoundingly approximately the same as that of the case of boron (B). From the location d_{I} is Rₚ=38.4 nm, the defect quantity Q_{I} is expressed as an expression (51).

Q_{I}=6.4×10¹⁴ cm⁻² (51)

If it is saturated by this dose, the proportionality constant r_{I}≈10 is significantly greater than the case of boron (B). It is known that indium (In) is trapped in the defect regions. This trap of the indium (In) may vary a concentration and the like to be released. The proportionality constant r_{I} is to be recognized as a parameter including the trap of the indium (In).

As described above, roughly, the defect quantity Q_{Isat} in the saturation state has less impurity dependency. Tentatively, the defect quantity Q_{I}=5×10¹⁴ cm⁻² is set as a common parameter.

[8-3. Maximum Diffusion Concentration N_{TEDMax}]

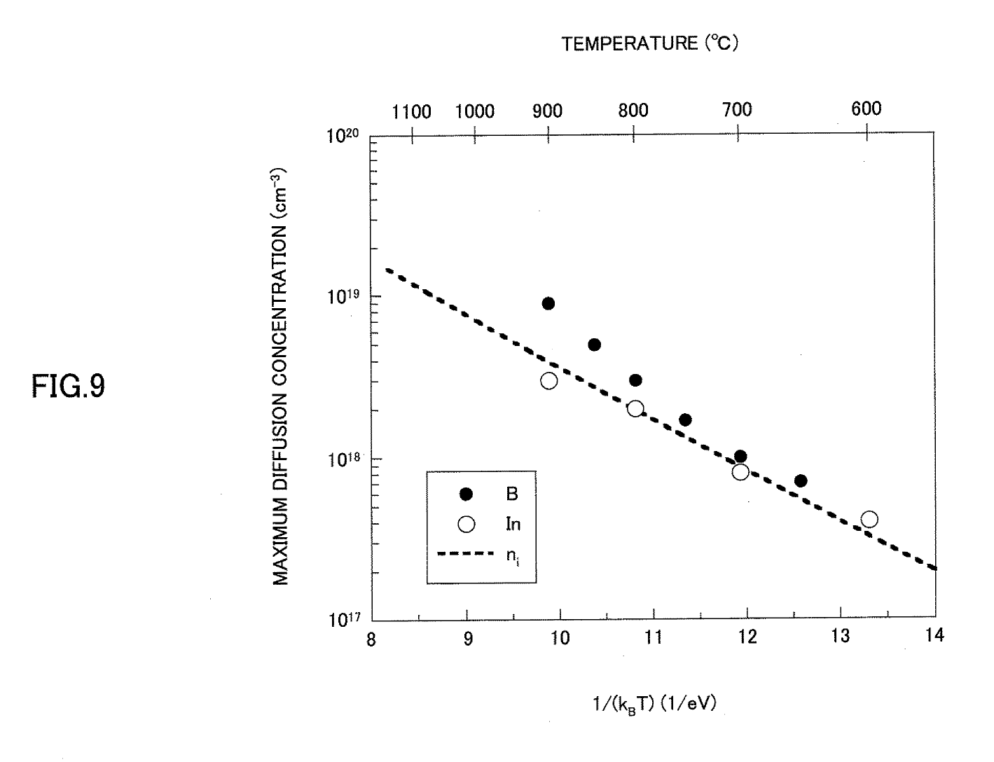

A temperature dependency of the maximum diffusion concentration N_{TEDMax} during the TED will be described with reference to FIG. 9. FIG. 9 is a graph illustrating a relationship between the maximum diffusion concentration N_{TEDMax} and an intrinsic carrier concentration nᵢ at a time of the enhanced diffusion. In FIG. 9, a vertical axis indicates the maximum diffusion concentration N_{TEDMax} and a horizontal axis indicates similarly to that of the graph in FIG. 4. In FIG. 9, the temperature dependency is illustrated for each of boron (B) and indium (In) in the maximum diffusion concentration N_{TEDMax} during the TED. The intrinsic carrier concentration nᵢ is also illustrated in FIG. 9.

In this case, above 900° C., it is not possible to associate the temperature with the TED. A value of the temperature is focused on below 900° C. As seen from FIG. 9, the maximum diffusion concentration N_{TEDMax} matches the intrinsic carrier concentration nᵢ quite well. It will be necessary to discuss whether this matching is accidental or has a physical meaning. In the embodiment, the maximum diffusion concentration N_{TEDMax} is simply dealt to be the intrinsic carrier concentration nᵢ as expressed by an expression (52).

N_{TEDMax}=nᵢ (52)

The intrinsic carrier concentration nᵢ is given by an expression (53) (refer to Non-Patent Document 24).

$$\begin{matrix}{n}_{i} = 3.87 \times {10}^{16} {T}^{\frac{3}{2}} exp [ - \frac{0.605 ( eV )}{{k}_{B} T} ] {cm}^{- 3} \\ = 2.01 \times {10}^{20} {( \frac{T}{300} )}^{\frac{3}{2}} exp [ - \frac{0.605 ( eV )}{{k}_{B} T} ] {cm}^{- 3}\end{matrix} \qquad ( 53 )$$

[9. Model Parameters]

Model parameters described above are summarized as follows.

The interstitial silicon concentration I* in the thermal equilibrium state is expressed by an expression (54).

$${I}^{*} = 7.5 \times {10}^{22} exp [ - \frac{2.4 eV}{{k}_{B} T} ] {cm}^{- 3} \qquad ( 54 )$$

The solubility limit concentration Iₛₒₗ of the interstitial silicon is expressed as an expression (55).

$${I}_{sol} = 2.03 \times {10}^{25} exp ( - \frac{1.913 ( eV )}{{k}_{B} T} ) ( {cm}^{- 3} ) \qquad ( 55 )$$

The diffusion coefficient D_{I} of the interstitial silicon is expressed as an expression (56).

$${D}_{I} = 600 exp [ - \frac{2.44 eV}{{k}_{B} T} ] {cm}^{2} \text{/} s \qquad ( 56 )$$

The maximum diffusion concentration N_{TEDMax} during the TED is expressed as an expression (57).

N_{TEDMax}=nᵢ (57)

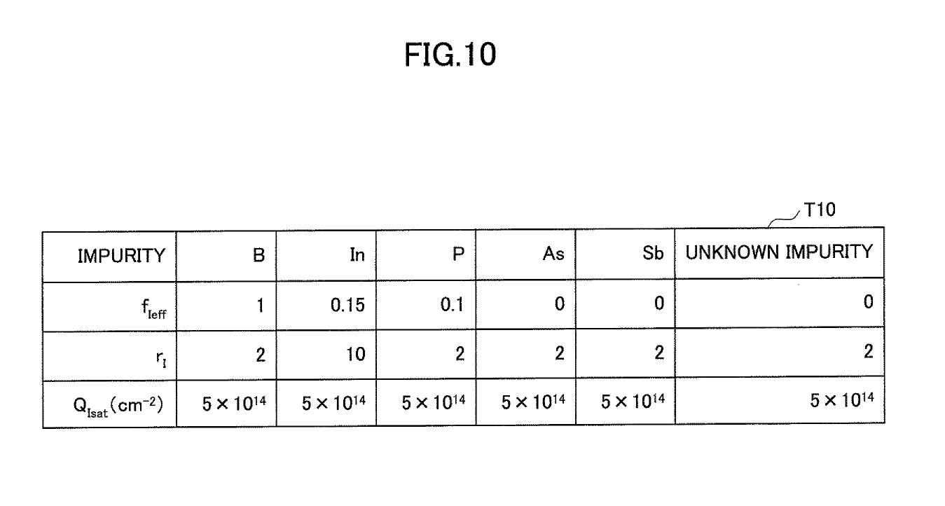

In the following, the above-described model parameters and parameter values acquired beforehand from experimental data for each impurity as illustrated in FIG. 10 are used. FIG. 10 is a table illustrating parameter values for each of impurities. The table T10 illustrated in FIG. 10 includes parameters of the flux f_{Ieff} indicating the degree of the pairing diffusion with the interstitial silicon, the proportionality constant r_{I}, the defect quantity Q_{Isat}, and the like, for each of impurities. As the impurities, boron (B), indium (In), phosphorus (P), arsenic (As), antimony (Sb), and unknown impurities are indicated.

The location d_{I} is expressed by an expression (58).

$${d}_{I} = \{ \begin{matrix}{R}_{p} & for Φ \leq 2 {Φ}_{a / c} \\ {R}_{p} + \sqrt{2} Δ {R}_{p} {erfc}^{- 1} ( \frac{2 {Φ}_{a / c}}{Φ} ) & for Φ > 2 {Φ}_{a / c}\end{matrix} \qquad ( 58 )$$

The defect quantity Q_{I} per unit area and the like are expressed by an expression (59).

$${Q}_{I} = \{ \begin{matrix}{r}_{I} Φ & for {r}_{I} \leq {Q}_{Isat} \\ {Q}_{Isat} & for {r}_{I} Φ > {Q}_{Isat}\end{matrix} \qquad ( 59 )$$

Alternatively, these parameters are expressed by an expression (60).

$${Q}_{I} = \{ \begin{matrix}{Q}_{Isat} ln \frac{Φ}{{Φ}_{crit}} & for Φ \leq {Φ}_{Isat} \\ {Q}_{Isat} & for Φ > {Φ}_{Isat}\end{matrix} \qquad ( 60 )$$

The TED duration tₑₙₕ in which the TED is consecutively progressing is expressed by an expression (61).

$${t}_{enh} = \frac{{d}_{I} {Q}_{I}}{{D}_{I} {I}_{sol}} \qquad ( 61 )$$

In general, the expression (61) is further expressed as an expression (62).

$${t}_{enh} = \frac{{Q}_{I}}{\frac{1}{\frac{{D}_{I}}{{d}_{I} h} + 1} {D}_{I} \frac{{I}_{sol}}{{d}_{I}} + \frac{{D}_{I} {I}_{sol}}{{L}_{DI}}} \qquad ( 62 )$$

Also, a diffusion equation during the TED can be expressed by an expression (63) using the diffusion coefficient Dₑₙₕ being the constant value.

$$\frac{\partial N ( x )}{\partial t} = \frac{\partial [ {D}_{enh} \frac{\partial N ( x )}{\partial x} ]}{\partial x} \qquad ( 63 )$$

The diffusion coefficient Dₑₙₕ can be acquired by an expression (64).

$${D}_{enh} = [ \frac{{I}_{sol}}{{I}^{*}} {f}_{Ieff} + \frac{{I}^{*}}{{I}_{sol}} ( 1 - {f}_{Ieff} ) ] {D}^{*} \qquad ( 64 )$$

A coefficient in the expression (64) is indicated by an expression (14). The maximum diffusion concentration N_{diffMax} is indicated by the maximum diffusion concentration N_{TEDMax} as expressed by an expression (65).

N_{diffMax}=N_{TEDMax} (65)

Furthermore, regardless of performing a heat process or not performing the heat process after the TED, the activation impurity concentration N_{act} at the end of the TED is determined as an expression (66).

N_{act}=Min[N_{chem},Nₛₒₗ(T_{TEDf})] (66)

In the expression (66), T_{TEDf} denotes temperature at the end of the TED.

A regular expression (67) is applied for following diffusion equations.

$$\frac{\partial N ( x )}{\partial t} = \frac{\partial [ {D}^{*} \frac{\partial N ( x )}{\partial x} ]}{\partial x} \qquad ( 67 )$$

In this case, the maximum diffusion concentration N_{diffMax} is the solubility limit Nₛₒₗ as expressed by an expression (68), and is calculated.

N_{diffMax}=Nₛₒₗ (68)

The coefficient may be calculated by using the temperature in the extremely shorter time during the ramp-up. However, it is required to determine whether or not the TED is in progress.

In a case in which the TED ends during the ramp-up, to obtain the TED end temperature T_{f}, first, the TED end time t_{f} is searched for and evaluated so as to satisfy an expression (69).

$$1 = {\int }_{0}^{{t}_{f}} \frac{1}{{t}_{enh} ( {T}_{0} + {r}_{rampU} t )} d t \qquad ( 69 )$$

Then, the TED end temperature T_{f} is acquired by an expression (70).

T_{f}=T₀+r_{rampU}t_{f} (70)

On the other hand, if the TED is consecutively progressed after the ramp-up ends, the effective time t_{eff} for a final temperature in the ramp-up is evaluated by an expression (71).

$${t}_{eff} = {\int }_{0}^{{t}_{ramp}} \frac{1}{{t}_{enh} ( {T}_{0} + {r}_{rampU} t )} d t \times {t}_{enh} ( {T}_{0} + {r}_{rampU} {t}_{ramp} ) \qquad ( 71 )$$

Since a constant temperature after the ramp-up is expressed by T₀+r_{rampU}tᵣₐₘₚ, the remaining TED time is expressed by an expression (72).

tₑₙₕ(T₀+r_{rampU}tᵣₐₘₚ)−t_{eff}(72)

After that, the thermal equilibrium diffusion may be simulated.

There is no guarantee to precisely express the TED by the simple model according to the embodiment. However, irrespective of the physical meaning in the simple model, there is a case in which it is desired to match the simple model to the experimental data. Parameters allowing a user to change values are provided to display at a display unit. Parameters dominating the TED are the diffusion coefficient Dₑₙₕ during the TED, the TED duration tₑₙₕ, and the maximum diffusion concentration N_{TEDMax} during the TED.

Parameters to change the diffusion coefficient Dₑₙₕ in the TED are the flux f_{Ieff} indicating the degree of the pairing diffusion, the solubility limit concentration Iₛₒₗ of the interstitial silicon, and the interstitial silicon concentration I* in the thermal equilibrium state.

The solubility limit concentration Iₛₒₗ of the interstitial silicon and the interstitial silicon concentration I* in the thermal equilibrium state are determined as an expression (73) and an expression (74), respectively.

$$\begin{matrix}{I}_{sol} = {I}_{sol\_ 0} exp ( - \frac{Δ {E}_{Isol}}{{k}_{B} T} ) {cm}^{- 3} & ( 73 ) \\ {I}^{*} = {I}_{0}^{*} exp ( - \frac{Δ {E}_{{I}^{*}}}{{k}_{B} T} ) {cm}^{- 3} & ( 74 )\end{matrix}$$

The flux f_{Ieff}, Iₛₒₗ_{_{—}}₀, ΔE_{Isol}, I*₀, and ΔE_{I}* are parameters to allow the user to change. This order has less relevance to another model.

The TED duration tₑₙₕ is relevant to the projection range Rₚ, a standard deviation ΔRₚ, and the like, which are associated with the solubility limit concentration Iₛₒₗ of the interstitial silicon and the implantation condition. If a wrong model, these relevancies are incorrect. In a case of matching to the experimental data, it may be desired to implement a function to define the TED duration tₑₙₕ on an experimental basis independent of the simple model. Accordingly, the TED duration tₑₙₕ is expressed as an expression (75).

$${t}_{enh} = {t}_{enh\_ 0} exp [ \frac{Δ {E}_{tenh}}{{k}_{B} T} ] sec \qquad ( 75 )$$

By providing the expression (75), the user can change parameters tₑₙₕ_{_{—}}₀ and ΔEtₑₙₕ_{_{—}}₀.

The maximum diffusion concentration N_{TEDMax} during the TED is based on the intrinsic carrier concentration nᵢ. Thus, the maximum diffusion concentration N_{TEDMax} is expressed by an expression (76).

$${N}_{TEDMax} = {{N}_{TEDMax\_ 0} ( \frac{T}{300} )}^{\frac{3}{2}} exp ( - \frac{Δ {E}_{NTEDMax}}{{k}_{B} T} ) {cm}^{- 3} \qquad ( 76 )$$

By providing the expression (76), the user can change parameters N_{TEDMax}_{_{—}}₀ and ΔE_{TEDMax}.

[10. Process Simulator]

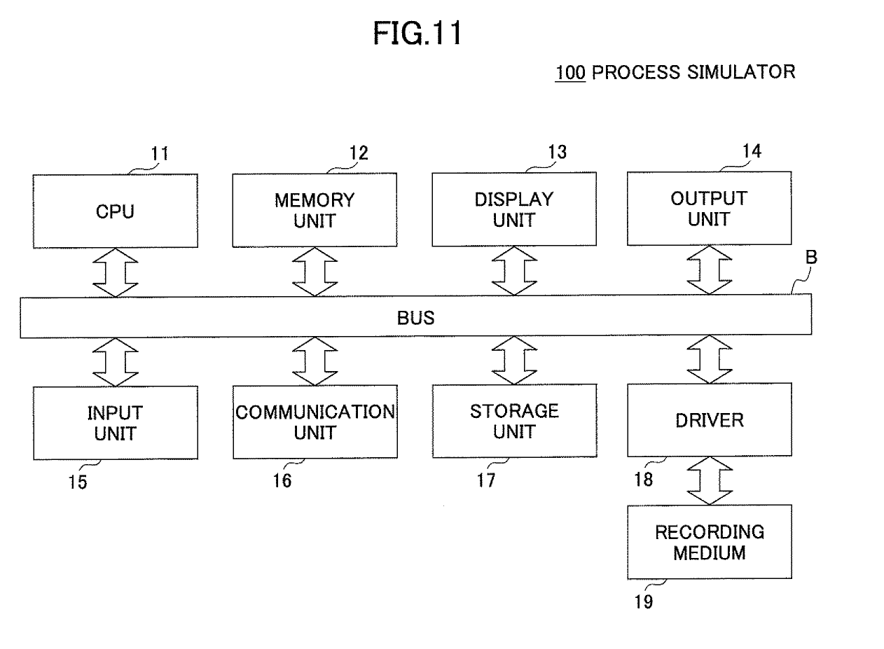

In the following, a process simulation, which implements the above described simple model according to the embodiment will be described. For example, a process simulator 100 according to the embodiment includes a hardware configuration as illustrated in FIG. 11. FIG. 11 is a block diagram illustrating the hardware configuration of the process simulator.

In FIG. 11, the process simulator 100 is a terminal controlled by a computer, and includes a CPU (Central Processing Unit) 11, a memory unit 12, a display unit 13, an output unit 14, an input unit 15, a communication unit 16, a storage unit 17, and a driver 18, which are mutually connected by a system bus B.

The CPU 11 controls the process simulator 100 in accordance with a program stored in the memory unit 12. The memory unit 12 includes a RAM (Random Access Memory), a ROM (Read-Only Memory), and the like, and stores programs executed by the CPU 11, data necessary for processes conducted by the CPU 11, data acquired by the processes, and the like. A part of an area of the memory unit 12 is assigned as a working area used for the processes conducted by the CPU 11.

The display unit 13 displays various necessary information under a control of the CPU 11. The output unit 14 includes a printer and the like, and is used to output various information in response to an instruction of a user. The input unit 15 includes a mouse, a keyboard, and the like, and is used for the user to input various information necessary to the processes which the process simulator 100 conducts. The communication unit 16 connects the Internet, a LAN (Local Area Network), and the like, for example, and is a device to control communications with an external apparatus. The storage unit 17 includes a hard disk unit, for example, and stores data of the programs conducting various processes, and the like.

For example, a program to realize a process conducted by the process simulator 100 is provided by a recording medium 19 such as CD-ROM (Compact Disc Read-Only Memory) or the like. That is, when the recording medium 19 storing the program is set into the driver 18, the driver 18 reads out the program from the recording medium 19, and the program being read is installed into the storage unit 17 via the system bus B. When the program is activated, the CPU 11 starts the process in accordance with the program installed into the storage unit 17. A medium to store the program is not limited to the CD-ROM, and may be any computer-readable recording medium. The program to realize the process according to the embodiment can be downloaded through a network by the communication unit 16, and is installed into the storage unit 17. Also, if the process simulator 100 supports a USB (Universal Serial Bus), the program may be installed from an external storage device capable of a USB connection. Furthermore, if the process simulator 100 supports a flash memory such as a SD (Secure Digital memory) card or the like, the program may be installed from the flash memory.

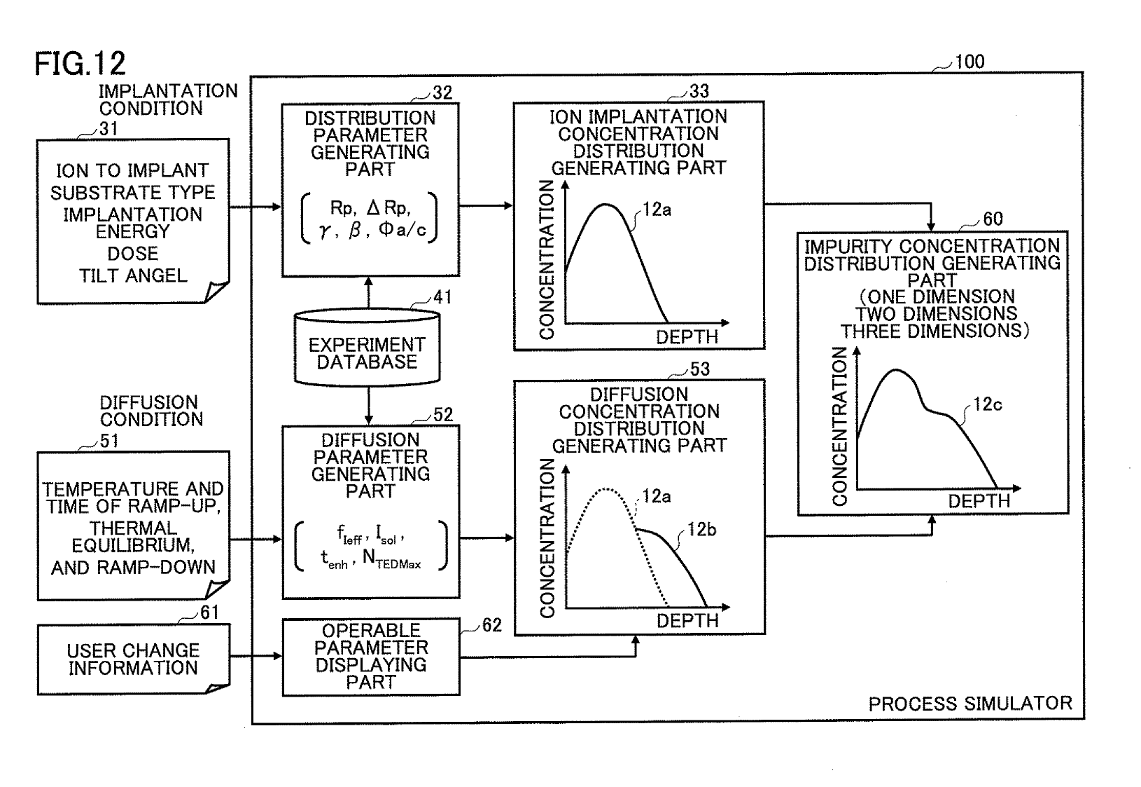

FIG. 12 is a diagram illustrating a functional configuration example of the process simulator 100. In FIG. 12, the process simulator 100 includes a distribution parameter generating part 32, an ion implantation concentration distribution generating part 33, an experiment database 41, a diffusion parameter generating part 52, a diffusion concentration distribution generating part 53, an impurity concentration distribution generating part 60, and an operable parameter displaying part 62.

The CPU 11 functions as each of the distribution parameter generating part 32, the ion implantation concentration distribution generating part 33, the diffusion parameter generating part 52, the diffusion concentration distribution generating part 53, the impurity concentration distribution generating part 60, and the operable parameter displaying part 62. Also, the experiment database 41 is stored in a storage area in the storage unit 17 or the memory unit 12.

The distribution parameter generating part 32 is a processing part which generates distribution parameters of the projection range Rₚ of the ion implantation, the standard deviation ΔRₚ, high order moments γ and β, a through dose Φ_{a/c}, and the like. An implantation condition 31 includes information items of an ion to implant, a substrate type, an implantation energy, a dose, a tilt angle, and the like, by using the experiment database 32 in response to an input of the implantation condition 31 from the user.

The ion implantation concentration distribution generating part 33 generates an ion implantation concentration distribution 12a, which is the impurity concentration distribution, in the ion implantation step by applying distribution parameters generated by the distribution parameter generating part 32 to the simple model expressed by the above described expressions according to the embodiment, and inputs the ion implantation concentration distribution 12a to the impurity concentration distribution generating part 60.

The diffusion parameter generating part 52 is a processing part which generates diffusion parameters: the flux f_{Ieff} indicating the degree of the pairing diffusion, the solubility limit concentration Iₛₒₗ of the interstitial silicon, the TED duration tₑₙₕ, the maximum diffusion concentration N_{TEDMax}, and the like by using the experiment database 32 in response to an input of a diffusion condition 51 from the user. The diffusion condition 51 includes information concerning temperature and time of a ramp-up, a thermal equilibrium, and a ramp-down.

The diffusion concentration distribution generating part 53 is a processing part which generates a diffusion concentration distribution 12b by applying the diffusion parameters generated by the diffusion parameter generating part 52 to the simple model expressed by the above described expressions according to the embodiment, and inputs the diffusion concentration distribution 12b to the impurity concentration distribution generating part 60. The diffusion concentration distribution 12b represents the impurity concentration distribution of a portion which is diffused from the ion implantation concentration distribution 12a in a depth direction due to the heat process step.

The impurity concentration distribution generating part 60 is a processing part which generates an impurity concentration distribution 12c after the heat process step entirely in one dimension, two dimensions, or three dimensions, by adding the ion implantation concentration distribution 12a input from the ion implantation concentration distribution generating part 33 and the diffusion concentration distribution 12b input from the diffusion concentration distribution generating part 53, and displays the entire impurity concentration distribution 12c after the heat process step. The impurity concentration distribution generating part 60 calculates an impurity concentration corresponding to a mesh size with respect to the semiconductor substrate to which the ion implantation is performed, in response to an indicated dimension by a numerical calculation, and generates the entire impurity concentration distribution 12c.

The operable parameter displaying part 62 displays parameters concerning a generation of the diffusion concentration distribution of the TED to allow the user to operate at the display unit 13, acquires user change information 61 including parameter values which are changed by the user, and inputs the parameter values to the diffusion concentration distribution generating part 53. By this functional configuration, the user can adjust the parameters to match the diffusion concentration distribution of the TED to data of the experiment database 41. The diffusion concentration distribution generating part 53 generates the diffusion concentration distribution 12b based on the user change information 61 input by the user through the operable parameter displaying part 62.

For example, the operable parameter displaying part 62 is a processing part which displays a screen for the user to operate the parameters at the display unit 13. By the screen displayed by the operable parameter displaying part 62, the user can change values of parameters: f_{Ieff}, Iₛₒₗ_{_{—}}₀, ΔE_{Isol}, I*₀, ΔE_{I}*, and the like concerning a change of the diffusion coefficient Dₑₙₕ during the TED, values of parameters: Rₚ, ΔRₚ, and the like concerning a change of the TED duration tₑₙₕ, and values of parameters: N_{TEDMax}_{_{—}}₀, ΔE_{TEDMax}, and the like concerning the maximum diffusion concentration N_{TEDMax} during the TED.

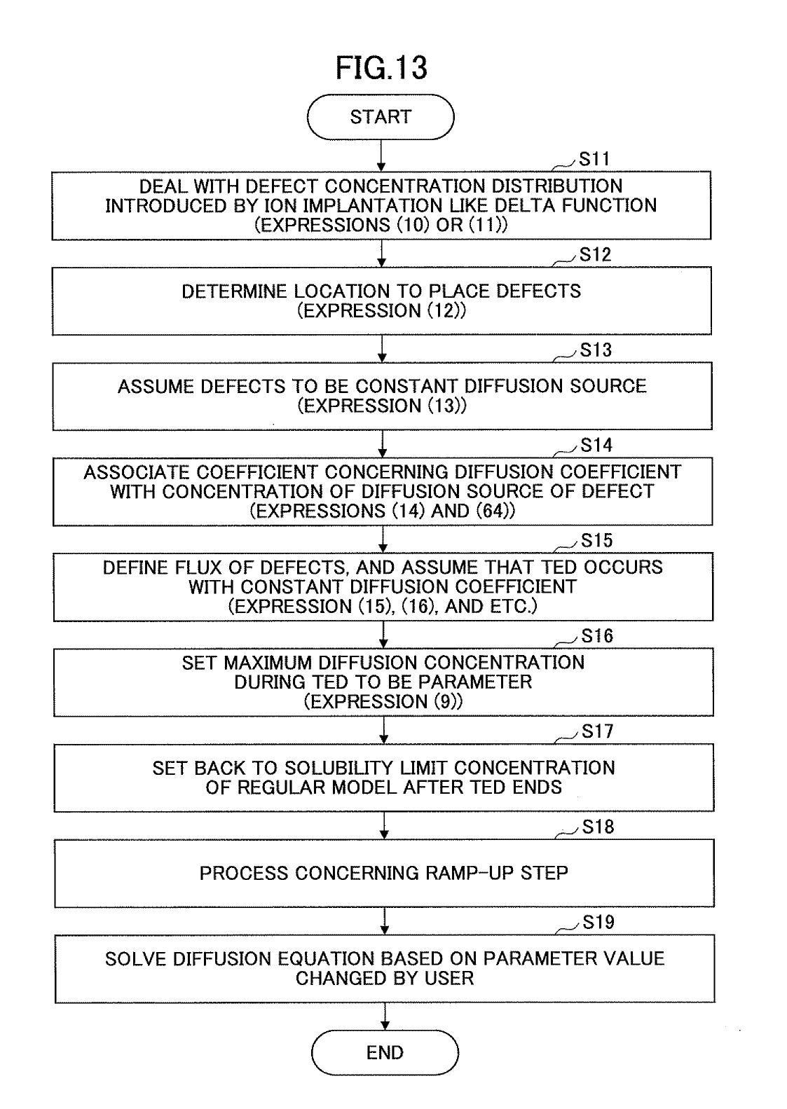

A process conducted by the diffusion concentration distribution generating part 53 will be described. FIG. 13 is a flowchart for explaining a process of how the diffusion concentration distribution occurs. In FIG. 13, the CPU 11 functioning as the diffusion concentration distribution generating part 53 acquires the defect quantity Q_{I} introduced per unit area to deal with the concentration distribution of defects introduced into the semiconductor substrate by the ion implantation (step S11). The CPU 11 acquires the defect quantity Q_{I} introduced per unit area expressed by the expression (10) and the expression (11), instead of the defect concentration distribution 2b in FIG. 2A having the expanse from the ion implantation concentration distribution 2a. Regarding the defect quantity Q_{I}, the CPU 11 normalizes time required to reach the defect quantity Q_{I} between different temperatures with a predetermined dose.

Subsequently, the CPU 11 defines the location d_{I} to place the defects (step S12). The CPU 11 acquires the location d_{I} by calculating the expression (12) in which in the ion implantation concentration distribution 12a, before the consecutive amorphous layer is formed, the location d_{I} is determined to be the projection range Rₚ (FIG. 2A), and after the amorphous layer is formed, the location d_{I} is defined at the a/c interface 2i (FIG. 2B).

Moreover, the defects are assumed to work as a constant diffusion source (step S13). The diffusion coefficient of the impurity associated with interstitial silicon is increased by a ratio (Iₛₒₗ/I* times) of the solubility limit concentration Iₛₒₗ of the interstitial silicon to the interstitial silicon concentration I*. On the other hand, the diffusion coefficient of the impurity associated with the vacancies is a ratio (V/V* times) of the vacancy concentration V to the vacancy concentration V* in the thermal equilibrium state. By using a relationship of IₛₒₗV=I*V* and from a relational expression of V expressed in the expression (13), this ratio can be expressed by I*/Iₛₒₗ as used in the expression (14).

A coefficient concerning the diffusion coefficient Dₑₙₕ during the TED is expressed by using concentrations of the diffusion source of the defects (the solubility limit concentration Iₛₒₗ of the interstitial silicon and the interstitial silicon concentration I* in the thermal equilibrium state) (step S14). The CPU 11 acquires the expression (14) from the expression (13) by applying the flux f_{Ieff} indicating the degree of the pairing diffusion for terms of the concentrations of the interstitial silicon and the vacancy concentrations. Since the coefficient concerning the diffusion coefficient Dₑₙₕ is expressed in the expression (14), the CPU 11 acquires the expression (64) to obtain the diffusion coefficient Dₑₙₕ.

Furthermore, the flux f_{I} of the defects is defined, and it is assumed that the TED occurs with the constant diffusion coefficient in the meantime of the flux f_{I} (step S15). To simplify, it is assumed that the interstitial silicon is assumed to disappear only on the surface of the semiconductor substrate, and the interstitial silicon of a constant concentration is released (that is, it is dealt with as the solubility limit Nₛₒₗ of the impurity). The CPU 11 defines the flux f_{I} of the defects by the expression (15) using the diffusion coefficient D_{I} of the interstitial silicon, the location d_{I}, and the solubility limit concentration Iₛₒₗ of the interstitial silicon.

Moreover, it is assumed that the flux f_{I} of the defects reaches the defect quantity Q_{I} if the flux f_{I} is sustained for the TED duration tₑₙₕ. Then, the CPU 11 acquires the expression (16) expressing the TED duration tₑₙₕ. Furthermore, the expression the (20) is acquired at the greater limit (infinite) of the sink coefficient (transport coefficient) h on the surface. The expression (21) is acquired at the smaller limit (finite). The expression (26) is acquired to consider diffusion in the depth direction deeper than the location d_{I} at the smaller limit. Then, the expression (27) is acquired in which the TED duration tₑₙₕ is more generally expressed.

Next, the CPU 11 sets the maximum diffusion concentration N_{TEDMax} to be a parameter during the TED, and solves the diffusion equation during the TED (step S16). The CPU 11 sets the intrinsic carrier concentration nᵢ to be the maximum diffusion concentration N_{TEDMax} by the expression (52). Also, the CPU 11 calculates the diffusion coefficient Dₑₙₕ by the expression (64) applying the expression (14), and solves the diffusion equation during the TED by the expression (8).

After the TED ends, the CPU 11 sets back to the solubility limit Nₛₒₗ of a regular model, and solves the diffusion equation (step S17). The CPU 11 sets back to the solubility limit Nₛₒₗ from the maximum diffusion concentration N_{diffMax} by the expression (7), and solves the diffusion equation after the TED ends by the expression (6) applying the diffusion coefficient D* in the thermal equilibrium state.

Next, the CPU 11 conducts the process concerning the ramp-up step (step S18). The CPU 11 determines the TED end time t_{f} when the TED ends in a case of the TED end temperature T_{f}, by the expression (31) (the expression (69)).

After that, the CPU 11 solves the diffusion equation based on the parameter values changed by the user (step S19). If there is no change by the user, this process in the step S19 is omitted. The CPU 11 calculates the diffusion coefficient Dₑₙₕ during the TED, the TED duration tₑₙₕ, and the maximum diffusion concentration N_{TEDMax} corresponding to the parameter values changed by the user. After that, the CPU 11 solves the diffusion equation during the TED by the expression (8).

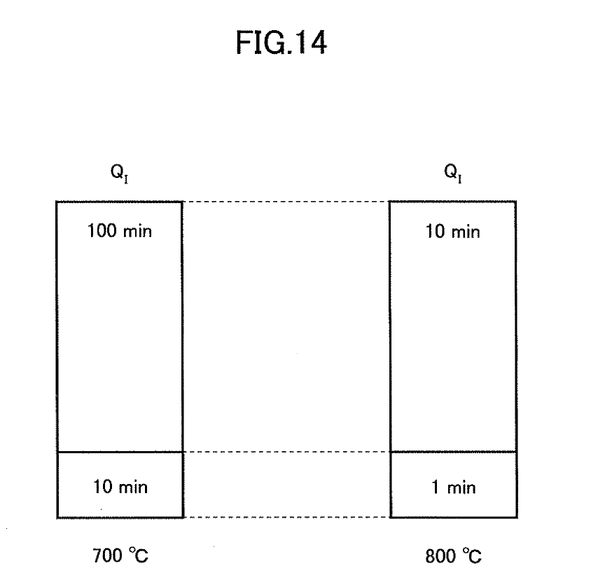

FIG. 14 is a diagram for explaining a normalization example of time until achieving the defect quantity Q_{I}. In the embodiment, in order to evaluate the TED duration tₑₙₕ, time until achieving the defect quantity Q_{I} between different temperatures is normalized beforehand. For example, as described with reference to FIG. 1, time is normalized with the dose 1×10¹⁵ cm⁻². In FIG. 14, the normalization example is illustrated in a case of different temperatures 700° C. and 800° C. It is assumed that 100 min is spent to achieve the defect quantity Q_{I} at 700° C. On the other hand, it is assumed that 10 minis spent to achieve the defect quantity Q_{I} at 800° C. In the following equation, time t_{700° C.} denotes time at 700° C. and time t_{800° C.} denotes time at 800° C.

time t_{700° C.}/100 min=time t_{800° C.}/10 min That is, the time is normalized so that 10 min at 700° C. corresponds to 1 min at 800° C.

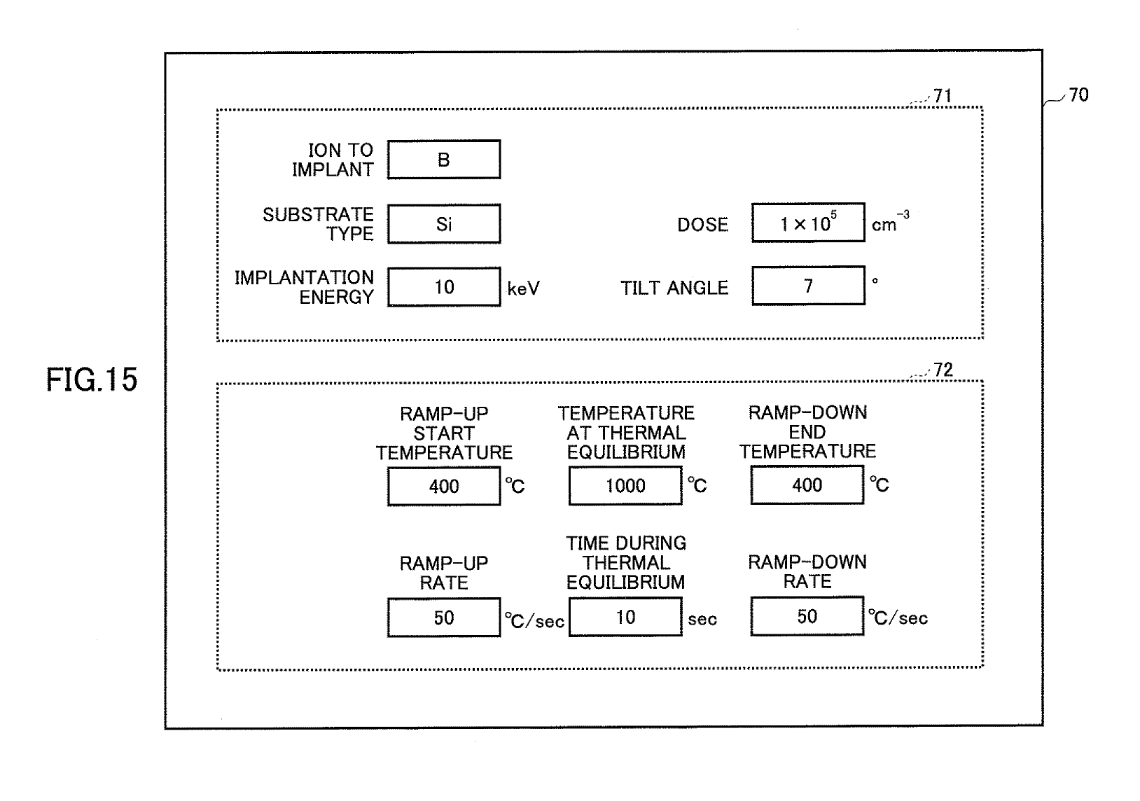

A screen example to input the implantation condition 31 and the diffusion condition 51 illustrated in FIG. 12 will be described in the following. FIG. 15 is a diagram illustrating an input screen example. An input screen 70 illustrated in FIG. 15 includes an implantation condition input area 71 to input the implantation condition 31, and a diffusion condition input area 72 to input the diffusion condition 51.

The implantation condition input area 71 is used to input a condition concerning the ion implantation step, and includes input areas of parameters: the ion to implant, the substrate type, the implantation energy, the dose, the tilt angle, and the like. For example, the user may input “B” in the input area for the ion to implant, “Si” in the input area for the substrate type, “10” keV in the input area for the implantation energy, “1×10⁵” cm⁻³ in the input area for the dose, “7”° in the input area for the tilt angle, and the like.

The diffusion condition input area 72 is used to input a condition concerning the heat process step, and includes input areas of parameters: start temperature and a ramp-up rate for the ramp-up, temperature and time at the thermal equilibrium, start temperature and a ramp-down rate for the ramp-down, and the like. For example, the user may input “400”° C. in the input area for the start temperature of the ramp-up, “50”° C./sec in the input area for the ramp-up rate, “100”° C. in the input area for the temperature at the thermal equilibrium, “10” sec in the input area for the time at the thermal equilibrium, “400”° C. in the input area for the start temperature of the ramp-down, and “50”° C./sec in the input area for the ramp-down rate.

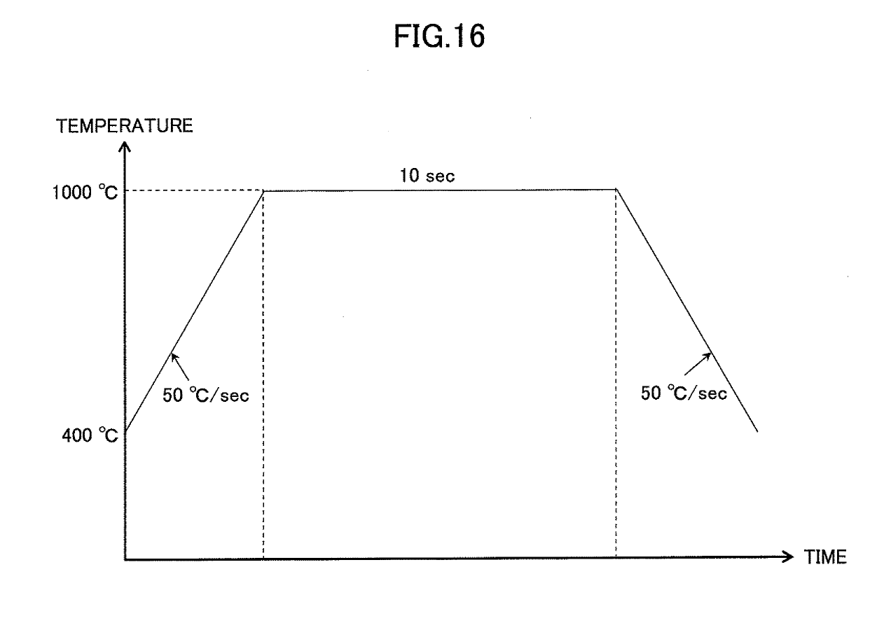

FIG. 16 is a diagram illustrating a setting example of the diffusion condition. In FIG. 16, an example of the heat process step is illustrated based on the diffusion condition 51 set at the input screen 70 illustrated in FIG. 15. In accordance with the diffusion condition 51 set at the input screen 70, the ramp-up is performed starting from 400° C. until achieving 1000° C. at the ramp-up rate of 50° C./sec. The thermal equilibrium state is retained for 10 sec after the ramp-up, and the ramp-down is started. The ramp-down is performed starting from 1000° C. in thermal equilibrium state until 400° C. at the ramp-down rate of 50° C./sec. Parameter values concerning this heat process step are set in the diffusion condition input area 72 as illustrated in FIG. 15, the diffusion concentration distribution during the heat process is simulated by the diffusion concentration distribution generating part 53 (FIG. 12).

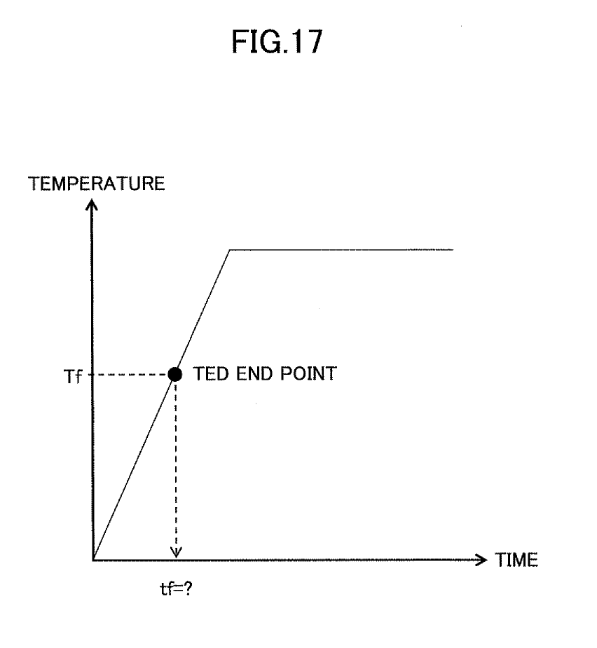

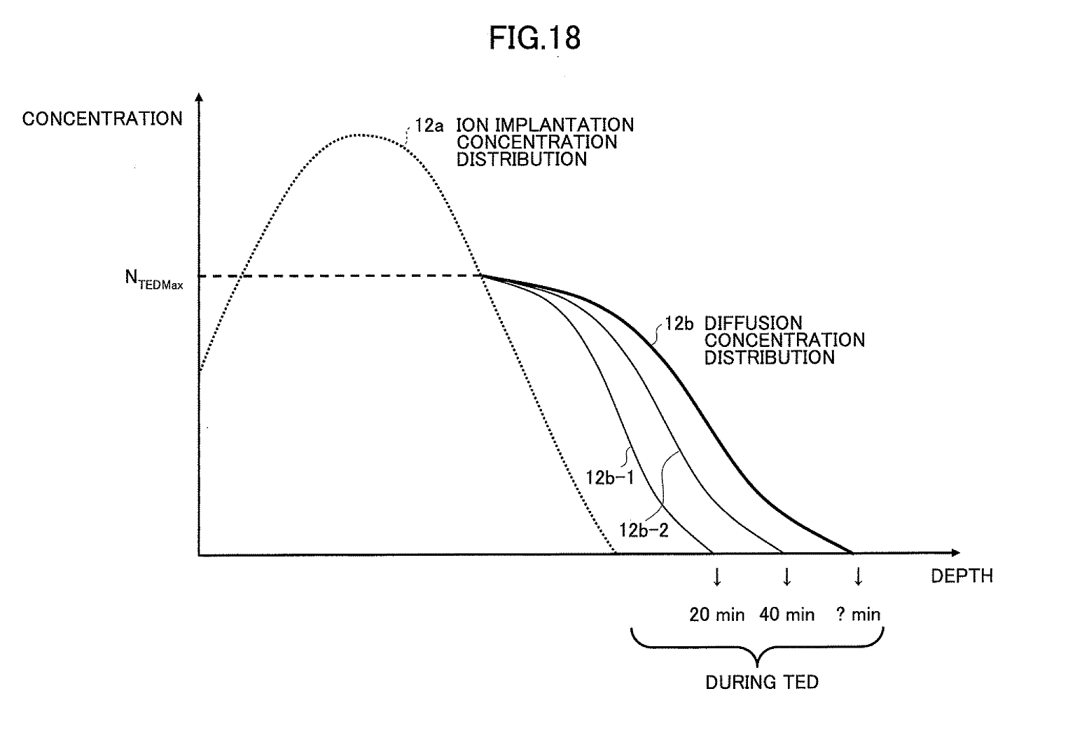

A TED end point will be described with reference to FIG. 17 and FIG. 18. FIG. 17 is a diagram for explaining the TED end point. In FIG. 18, a case in which the TED end point occurs during the ramp-up is illustrated. FIG. 18 is a diagram for explaining a search example of the TED end point. In FIG. 18, a vertical axis indicates a concentration, and a horizontal axis indicates the depth direction from the surface of the semiconductor substrate. The ion implantation concentration distribution 12a in the ion implantation step and the diffusion concentration distribution 12b in the heat process step are illustrated. The entire impurity concentration distribution is depicted by the ion implantation concentration distribution 12a and the diffusion concentration distribution 12b.

From the experimental data of the impurity concentration distribution concerning the heat process in the experimental database 41, it is possible to know a state in which the ion implantation concentration distribution 12a as illustrated in FIG. 18 is diffused toward the depth direction. However, it is not possible to know the TED end time t_{f} when the TED ends (FIG. 17). Thus, the TED end time t_{f} is predicted by the simulation using the diffusion concentration distribution generating part 53.

In FIG. 18, the maximum diffusion concentration N_{TEDMax} during the TED can be acquired from the expression (52). From the expression (8), the diffusion coefficient Dₑₙₕ is acquired for each of the diffusion portions 12b-1 and 12b-2 so as to match to the experimental data of the experimental database 41. For example, if “20” minutes corresponding to the diffusion portion 12b-1 from a TED start is acquired as matched with the experimental data and “40” minutes corresponding to the diffusion portion 12b-2 from the TED start is acquired as matched with the experimental data, the diffusion coefficient Dₑₙₕ during the TED is acquired by using the expression (8).

Regarding the diffusion concentration distribution 12b in which the diffusion state is retained, time t is calculated by applying the maximum diffusion concentration N_{TEDMax} during the TED and the diffusion coefficient Dₑₙₕ during the TED to the expression (8). The time t is acquired as the TED end time t_{f}. The time t indicates the shortest time until the state of the diffusion concentration distribution 12b. As described above, the TED end temperature I_{f} can be acquired from the expressions (31) and (32) (the expressions (69) and (70)).

As described above, in the embodiment, the defect quantity Q_{I} per unit area of the defects introduced into the semiconductor substrate by the ion implantation is placed at the location d_{I} being one point location in the ion implantation concentration distribution. By dealing with the defect concentration distribution as the delta function, and by assuming that the solubility limit concentration Iₛₒₗ of the interstitial silicon exists at the location d_{I} and the interstitial silicon disappears on the surface of the semiconductor substrate, individual models can be corresponded to the diffusion coefficient Dₑₙₕ during the TED, the TED duration tₑₙₕ, and the maximum diffusion concentration N_{TEDMax}.

According to the embodiment, the defects introduced by the ion implantation to the semiconductor substrate are placed at a predetermined location in the depth direction in the ion implantation concentration distribution, so as to deal with the defect concentration distribution as the delta function. Therefore, it is possible to calculate a generation of the diffusion concentration distribution during the TED by the simple model.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A diffusion concentration distribution generating method performed in a process simulator including a computer having computer-readable instructions stored in a non-transitive computer-readable storage device, in which the computer-readable instructions when executed by the computer cause the computer to generate a diffusion concentration distribution, said diffusion concentration distribution generating method comprising:
calculating a defect quantity Q_{I} per unit area of the defects introduced into a semiconductor substrate by an ion implantation; and
calculating a location d_{I} at which a defect concentration distribution is condensed and placed in an ion implantation concentration distribution due to the ion implantation,
wherein the defect concentration distribution is dealt with as a delta function.

2. The diffusion concentration distribution generating method as claimed in claim 1, wherein when the location d_{I} is calculated, the computer sets a projection range Rₚ to the location d_{I} before a consecutive amorphous layer is formed, and sets a location of an amorphous/channel interface to the location d_{I} after the consecutive amorphous layer is formed.

3. The diffusion concentration distribution generating method as claimed in claim 2, further comprising:
calculating a vacancy concentration V as I=Iₛₒₗ in a relationship of I*V*=IV when I* denotes an interstitial silicon concentration in a thermal equilibrium state, V* denotes a vacancy concentration in the thermal equilibrium state, and I and V denote respective regular concentrations,
wherein a solubility limit concentration Iₛₒₗ of the interstitial silicon is assumed to work as a constant concentration diffusion source of the interstitial silicon.

4. The diffusion concentration distribution generating method as claimed in claim 3, further comprising:
associating a coefficient concerning a diffusion coefficient Dₑₙₕ during a TED with the vacancy concentration V.

5. The diffusion concentration distribution generating method as claimed in claim 1, further comprising:
defining a flux f_{I} of the defects by multiplying a diffusion coefficient D_{I} of the interstitial silicon with a value which is acquired by dividing the solubility limit concentration Iₛₒₗ of the interstitial silicon with the location d_{I},
wherein the interstitial silicon is assumed to disappear on a surface of the semiconductor substrate, and the solubility limit concentration Iₛₒₗ of the interstitial silicon is assumed to exist at the location d_{I} in a depth direction from the surface where the defect quantity Q_{I} is placed.

6. The diffusion concentration distribution generating method as claimed in claim 5, further comprising:
calculating TED duration tₑₙₕ based on a definition of the flux f_{I} and the defect quantity Q_{I}
wherein the defect quantity Q_{I} is assumed to be achieved when the flux f_{I} of the defects lasts in the TED duration tₑₙₕ.

7. The diffusion concentration distribution generating method as claimed in claim 6, further comprising:
setting an intrinsic carrier concentration nᵢ to a maximum diffusion concentration N_{TEDMax} during the TED;
calculating a diffusion coefficient Dₑₙₕ during the TED by multiplying a coefficient concerning the diffusion coefficient Dₑₙₕ with a diffusion coefficient D* in a thermal equilibrium state, the coefficient being associated with the vacancy concentration V; and
solving a diffusion equation during the TED in which the diffusion coefficient D* is applied.

8. The diffusion concentration distribution generating method as claimed in claim 7, further comprising:
solving a diffusion equation after the TED ends, wherein the maximum diffusion concentration N_{TEDMax} is set back to be a solubility limit Nₛₒₗ of a regular model after the TED ends, and the diffusion coefficient D* in the thermal equilibrium state is applied.

9. The diffusion concentration distribution generating method as claimed in claim 8, further comprising:
calculating TED end time t_{f} based on temperature when the TED ends;
solving a diffusion equation to acquire thermal equilibrium diffusion as an activation impurity concentration N_{act} is set to be the solubility limit Nₛₒₗ after the TED end time t_{f} when the TED end time t_{f} is time after a ramp-up.

10. The diffusion concentration distribution generating method as claimed in claim 9, further comprising:
displaying a screen which allows a user to change the diffusion coefficient Dₑₙₕ during the TED, the TED duration tₑₙₕ, and the maximum diffusion concentration N_{TEDMax}.

11. The diffusion concentration distribution generating method as claimed in claim 5, wherein the flux f_{I} is calculated by one of a first expression when a sink coefficient h is a greater limit, a second expression when the sink coefficient h is a smaller limit, and a third expression when the sink coefficient h is the smaller limit and diffusion in the depth direction deeper than the location d_{I} is considered.

12. A process simulator including a computer having computer-readable instructions stored in a non-transitive computer-readable storage device, in which the computer-readable instructions when executed by the computer cause the computer to generate a diffusion concentration distribution in a heat process step after an ion implantation to a semiconductor substrate, said process simulator comprising:
a defect quantity calculating part configured to calculate defect quantity Q_{I} per unit area of the defects introduced into a semiconductor substrate by an ion implantation; and
a defect location calculating part configured to calculate a location d_{I} at which a defect concentration distribution is condensed and placed in an ion implantation concentration distribution due to the ion implantation,
wherein the defect concentration distribution is dealt with as a delta function.

13. A non-transitive computer-readable recording medium storing executable instructions, which when executed by a computer, causes the computer to perform:
calculating a defect quantity Q_{I} per unit area of the defects introduced into a semiconductor substrate by an ion implantation; and
calculating a location d_{I} at which a defect concentration distribution is condensed and placed in an ion implantation concentration distribution due to the ion implantation,
wherein the defect concentration distribution is dealt with as a delta function.
